(19) United States
(12) Patent Application Publication
(10) Pub. No.: US 2015/0223491 A1
(43) Pub. Date: Aug. 13, 2015

(54) SYSTEM AND METHOD FOR FODDER GENERATION

(71) Applicant: PRECISION HARVEST, LLC, Vineyard, UT (US)

(72) Inventors: Darin Frampton, Lindon, UT (US); Daniel Nelson, Lindon, UT (US)

(21) Appl. No.: 14/615,399

(22) Filed: Feb. 5, 2015

Related U.S. Application Data
(60) Provisional application No. 61/937,423, filed on Feb. 7, 2014.

(51) Int. Cl. A23K 1/00; G05D 7/06; G05B 15/02

(52) U.S. Cl. CPC A23K 1/001; G05B 15/02; G05D 7/0617

(57) ABSTRACT

In one example, a foddering machine is provided that includes a number of seeding trays and a transport system engaged with the seeding trays and operable to move the seeding trays between a variety of vertical and horizontal positions. The transport system includes two or more sheaves, a transport sprocket, a transport chain configured to engage the sheaves and transport sprocket, and motor coupled directly, or indirectly, to the transport chain. As well, a watering system dispenses water into the seeding trays, and a lighting system provides light to contents of the seeding trays. The seeding trays are filled by way of a hopper positioned to dispense seed into successive seeding trays. Finally, an automatic control system is coupled to the transport system, watering system, lighting system and hopper, and operates to automatically control the operation of the transport system, watering system, lighting system and hopper.

### RELATED APPLICATIONS

This application claims priority to, and the benefit of, U.S. Provisional Patent Application Ser. 61/937,423, entitled SYSTEM AND METHOD FOR FODDER GENERATION, filed Feb. 7, 2014, and incorporated herein in its entirety by this reference.

### FIELD OF THE INVENTION

The present disclosure is generally concerned with systems, machines and methods for fodder generation.

### BACKGROUND

Farmers have traditionally relied on planted feed crops to provide healthy and nutritious fodder for their livestock. However, a variety of considerations have diminished the viability and attractiveness of these methods for feeding livestock. For example, in many countries, there is a limited availability of livestock range and, where such range does exist, it is increasingly subjected to influences that reduce or eliminate its availability to livestock. As another example, the inherent unpredictability of weather contributes to the unreliable availability of fodder, and in some regions of the world, droughts present a particular problem. As a further example, planted crops are relatively inefficient in terms of the amount of fodder yield per unit of land. This lack of efficiency causes planted crops to be relatively expensive. As a final example, planted crops are labor-intensive, even where modern farm machinery is employed.

Attempts have been made to address one or more of the aforementioned concerns using hydroponically grown fodder. However, many fodder growing systems are largely manually operated and thus require a relatively large degree of operator involvement and attention, typically on a daily basis. For example, in many such systems, the farmer or other grower must slide the mature feed out of trays, rinse each tray, then reseed and push the newly seeded tray back into its rack. This entire process is performed manually. As a result of the labor-intensive nature of these types of growing systems, costs may not be significantly reduced relative to non-hydroponic growing methods and, at the least, may be prone to problems symptomatic of processes that are largely manual, including quality control problems.

While attempts have been made to improve performance by automating aspects of the fodder growing process, such attempts have often resulted in mechanically complex, expensive, and unreliable equipment. Thus, any benefits that may have been achieved due to automation may be largely negated by considerations such as these.

In light of the foregoing, it would be desirable to be able to reliably produce high quality fodder, notwithstanding variable weather conditions and/or lack of rangeland. As well, it would be desirable to generate relatively high yields. Finally, it would be useful to be able to reliably, economically and effectively automate some or all of the fodder generation process.

### BRIEF SUMMARY OF SOME ASPECTS OF THE DISCLOSURE

It should be noted that the embodiments disclosed herein do not constitute an exhaustive summary of all possible embodiments, nor does this brief summary constitute an exhaustive list of all aspects of any particular embodiment(s). Rather, this brief summary simply presents selected aspects of some example embodiments. It should be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should such embodiments be construed to implement, or be limited to implementation of, any particular technical effect(s) or solution(s).

Disclosed embodiments are generally concerned with apparatus, systems and methods for generation of hydroponic fodder. In one embodiment, discussed here for the purpose of illustration, an automated foddering machine residing in an 8×12 insulated and climate-controlled container, which may be portable, is provided. Only a water source and power source are needed to operate the foddering machine, which is otherwise self-contained. In some instances, the power may be supplied by stand-alone power sources such as solar panels, or a windmill.

The foddering machine is largely, or fully, automated and programmable by the user. Such control can be enabled by a control panel, which can be mounted to the machine enclosure or, where no machine enclosure is employed, can be mounted on or near the foddering machine. The control panel may include a touch screen interface, although any other type of user interface(s) could be used.

In this example embodiment, the foddering machine operates on a transport principle that operates on a 6 day cycle where fodder is produced 6 days after initial seeding. Using the transport principle, and with an adequate number of trays, a new crop of fodder is available every day in the cycle.

Essentially, the only manual labor that is required for operation of this embodiment of the foddering machine is periodic filling up of the hopper of the foddering machine with the seed, although it will be appreciated that that process could be automated as well. The foddering machine may include a sensor and alarm to alert the user when the amount of seed in the hopper falls below a desired level.

This particular example of the foddering machine includes about 120 trays which are about 7 feet long by about 11 inches wide. For initial seeding, the trays are fed from the hopper with about 4 to about 10 pounds of seed in each tray. With this amount of seed, and once all of the 120 trays have been seeded, the foddering machine can produce between about 1,000 to about 1,200 pounds of fodder each day. In this example embodiment, and starting with an empty foddering machine, 20 trays are seeded each day until, on the sixth day, the mature fodder is dumped out of the foddering machine. Thus, if the foddering machine starts completely empty, it will take 6 days before all of the trays have been seeded and before the first crop of fodder is mature and ready for harvest.

Of course, the amount of fodder produced daily by any given embodiment of the foddering machine will depend on variables including, but not limited to, cycle time, type and amount of seed used, amount of light, amount of watering, air temperature, water temperature, and any other variable that can impact growth rate of the seed used as fodder.

In one example, this machine runs on a 6 day cycle as follows: days 1-2, the seeds are watered, but receive little or no light; day 3, the seeds receive ultraviolet (UV) light generated by one or more light emitting diodes (LED); and, days 4-6, the sprouts receive light nearly 24 hours per day, and are also watered once every hour for about 30-50 seconds and then left in the light so that they can continue the process of sprouting. Of course, a wide variety of different types of seeds can be employed. In one particular example, feed quality barley is used that germinates within about 24 hours of seeding.

In terms of the growing environment, any of the variables affecting growth can be varied, either alone or in combination with one or more other variables. Such variables include air temperature, humidity level, oxygen concentration, carbon dioxide concentration, hours of light, amount of water, frequency of watering, and water temperature. With reference to the particular example of barley, a desirable temperature for growing barley fodder is in the range of about 65 degrees F. to about 75 degrees F. It may take about six days for the barley to grow from seeding to feed out, that is, to a state where it can be used as feed. In this example, barley grows in the same tray for about 6 days and, when ready for harvest, is in the form of a ‘grass’ mat in a range of about 6 inches to about 8 inches high.

It should be understood that the foregoing embodiment is provided solely by way of example and is not intended to limit the scope of the invention in any way. More generally, any one or more aspects of the machine can be scaled up or down in size and/or number to accommodate different fodder capacities and harvest sizes. With continuing reference now to further example embodiments, it should be understood that embodiments within the scope of this disclosure may include any one or more of the following elements, and features of elements, in any combination: a foddering machine whose operation is automated with respect to any one or more of climate control, seeding, lighting, watering, harvesting, and hopper replenishment; an automated climate control system that automatically controls, and can adjust at any time, any one or more of air temperature, water temperature, water volume, watering frequency, oxygen content, carbon dioxide content, humidity, and airflow; a climate control system operable to communicate wirelessly with a network, network node, and/or other remote system or device; a climate control system that can be remotely controlled and/or operated, such as by commands received by way of a wireless network or other wireless communication system; an application program (sometimes referred to as an “APP”) that can be installed on a mobile phone or similar device, such as devices that include one of the Android® or iOS® operating systems for example, and is operable to remotely and/or directly control and/or operate a climate control system such as one or more of those disclosed herein; a seeding tray including one or more cam surfaces that enable imposition of a desired amount of rotation to the growing tray; a seeding tray including one or more cam surfaces that enable automatic dumping of fodder from the tray as the seeding tray moves past a corresponding cam element that may, for example, be mounted to a frame of the foddering machine; a seeding tray that is rotatable about a longitudinal axis defined by the growing tray; a seeding tray configured to releasably engage a transport system; a seeding tray made substantially of plastic, or a corrosion-resistant metal such as stainless steel or aluminum; a system, means, and/or components for wireless communication, which can include data transmission and/or remote control, between a climate control panel and one or more remote devices; one or more solar panels; an enclosure, which may be insulated, that is ventilated, heated, humidity controlled, and/or air-conditioned; a portable enclosure, which may be trailerable; a lighting system, which may include any suitable lighting elements, examples of which include UV emitting LEDs; a watering system; a steam cleaning system for cleaning trays; an automatically activated hopper; a transport system that may take the form of a transport chain system and motor, which may be remotely controlled by wireless commands, operable to move a plurality of seeding trays into and out of a plurality of different positions including, for example, one or more vertical and/or one or more horizontal positions; a transport system operable to move one or more seeding trays into a plurality of different vertical positions, as well as back and forth along a length of the foddering machine; a transport chain that includes support elements, and associated bearings, to which one or more seeding trays can be removably connected; a transport chain from which one or more growing trays can be removably suspended; an open link transport chain and one or more sheaves configured to engage the open link transport chain; a sheave that includes a central groove configured to engage an open link transport chain, and the sheave including a pair of walls that slope toward the central groove; a sprocket with one or more removable teeth, and configured to engage an open link transport chain; a timer and/or clock operably connected with a transport system, such as a transport chain system for example, so as to facilitate control of the movement of the transport chain system and associated seeding trays; a proximity sensor operably connected with the hopper such that detection, by the proximity sensor, of a support element or other trigger device in the transport chain causes operation of the hopper; a rail configured to guide, and at least partly confine, a transport chain and/or support elements associated with the transport chain, wherein the rail may take the form of an extruded element; clocks and/or timers that facilitate control of any function, or combination of functions, associated with an automatic foddering machine as exemplified by the embodiments disclosed herein; and software, a method, a computer program product carrying executable instructions, and a hardware processor programmed with executable instructions, a non-transitory storage medium carrying executable instructions—all for carrying out one or more methods, examples of which include a method for controlling operation of a foddering machine, a method for automatically controlling climate associated with a foddering machine, and a method for recording data concerning any combination of one or more parameters associated with a foddering machine where such parameters include, but are not limited to, power consumption, water consumption, climate variables such as those disclosed herein, amount of seed used, and weight of fodder produced per unit weight of seed and/or water.

As well, this disclosure embraces the embodiments disclosed herein both in respective assembled forms, and in respective kit forms. When in the form of a kit, the embodiment may be partly or completely disassembled.

### BRIEF DESCRIPTION OF THE DRAWINGS

The appended drawings contain figures of some example embodiments to further clarify various aspects of the present disclosure. It will be appreciated that these drawings depict only some embodiments of the disclosure and are not intended to limit its scope in any way. The disclosure will be described and explained with additional specificity and detail through the use of the accompanying drawings in which:

FIG. 1 is a front perspective view of an example foddering machine housed in a portable enclosure;

FIG. 2a is a partial front perspective view of an example foddering machine housed and disclosing elements of an example watering system;

FIG. 2b is a detail view of a portion of a watering system;

FIG. 3 is a partial front perspective view of an example foddering machine housed and disclosing elements of an example hopper, transport system, and seeding tray;

FIG. 4 is a side perspective view of an example foddering machine and disclosing aspects of an example transport chain path, control panel, watering system and lighting system;

FIG. 5 is a side perspective view of an example foddering machine and disclosing aspects of an example transport chain path, control panel, watering system and lighting system;

FIG. 6 is a partial front perspective view of an example foddering machine and disclosing aspects of an example hopper, transport system, seeding tray, transport chain path, control panel, watering system and lighting system;

FIG. 7 is a partial side view of an example foddering machine and disclosing aspects of an example transport chain path, transport system, and control panel;

FIG. 8 is a perspective view of an example seeding tray;

FIGS. 9a and 9b are partial perspective views of an example seeding tray and disclosing aspects of an example transport chain, cam surface and seeding tray configuration;

FIG. 10 discloses aspects of an example support element such as may be employed in connection with a transport chain of a transport system;

FIG. 11 is a bottom perspective view of an example hopper;

FIG. 12 is a detail view of a portion of an example track element.

FIG. 13 is a diagram of a control system for a foddering machine;

FIG. 14a is a front perspective view of another embodiment of a foddering machine;

FIG. 14b is a rear perspective view of the foddering machine of FIG. 14a;

FIG. 15a is a right side view of the foddering machine of FIGS. 14a and 14b;

FIG. 15b is a front view of the foddering machine of FIGS. 14a and 14b;

FIG. 15c is a top view of the foddering machine of FIGS. 14a and 14b;

FIG. 16a is a section view taken from FIG. 15c and showing a left interior side of the foddering machine of FIGS. 14a and 14b;

FIG. 16b is a detail view disclosing connection of a motor to a shaft;

FIGS. 16c and 16d are detail views disclosing connection of the shaft to drive sprockets;

FIG. 17 is a partial front perspective view of the foddering machine of FIGS. 14a and 14b;

FIG. 18 is a detail view of an example sheave;

FIGS. 19a-19d are detail views of an example transport sprocket;

FIG. 20 is a detail view of a connection of a tray to a transport chain;

FIG. 21a is an example pump of a watering system; and

FIG. 21b is a partial detail view of watering system controls.

### DETAILED DESCRIPTION OF SOME EXAMPLE EMBODIMENTS

The present disclosure is generally concerned with apparatus, systems and methods for hydroponic generation of fodder. More specifically, embodiments of the invention include an apparatus that implements largely, or fully automated hydroponic generation of fodder, while also providing a high degree of customization in terms of the growing environment. Embodiments of the invention can be employed in a wide variety of applications and, accordingly, the scope of the invention is not limited to the example applications and structures disclosed herein.

### A. General Aspects of Some Example Embodiments

The word fodder is an old terminology for dried hay or feed, for cattle and other livestock. More recently, fodder refers to sprouted seed which is used as feed for cattle and other animals. Fodder is a more natural feed than many products currently used and is better suited to the digestive systems of livestock and horses. Due to its increased digestibility and the availability of nutrients, there is a wide range of benefits to feeding fodder over grains and concentrates. Not only will animals be healthier and have a better quality of life, they will also be more productive and profitable.

Any type of seed can be used in connection with one or more embodiments of the invention and while particular examples of seed types are disclosed herein, those are presented solely by way of example and are not intended to limit the scope of the invention in any way. Thus, in addition to the barley seed noted herein, other examples of seeds that can be used to generate fodder include alfalfa, wheat, and corn. Although a single type of seed is typically employed in any given crop produced by a foddering machine, seed types can be mixed within a seeding tray and/or can change from one seeding tray to the next.

Many of the elements employed in the foddering are constructed, either in whole or in part, of one or more metals. Suitable metals may include steels such as stainless steel, aluminum, and aluminum alloys, although the skilled person will understand that a variety of other metals may be employed as well and the scope of the invention is not limited to the foregoing examples. Where metal is employed in the construction of a component, the metal elements may take one or more forms including, but not limited to, square tube, rectangular tube, oval tube, polygonal tube, round tube, pipe, and solid, rather than tubular, forms of any of the foregoing. Metal elements can be extruded, forged, machined, or any of the foregoing. Materials such as plastics, including polytetrafluoroethylene (PTFE), sold under the mark Teflon®, and polyvinyl chloride (PVC), can be used either alone or in combination with one or more metals, in the construction of elements of the foddering machine. For example, cam surfaces of a seeding tray and/or a complementary element of a cam surface of a seeding tray may include a plastic portion that reduces friction between moving parts that contact each other.

Some, none, or all portions of one or more of the foddering equipment and its components may be coated with paint or other materials. At least some of such materials may serve to help prevent, or reduce, rust and corrosion. Surface treatments and textures may also be applied to portions of the foddering machine.

### B. Structural Aspects of An Example Embodiment

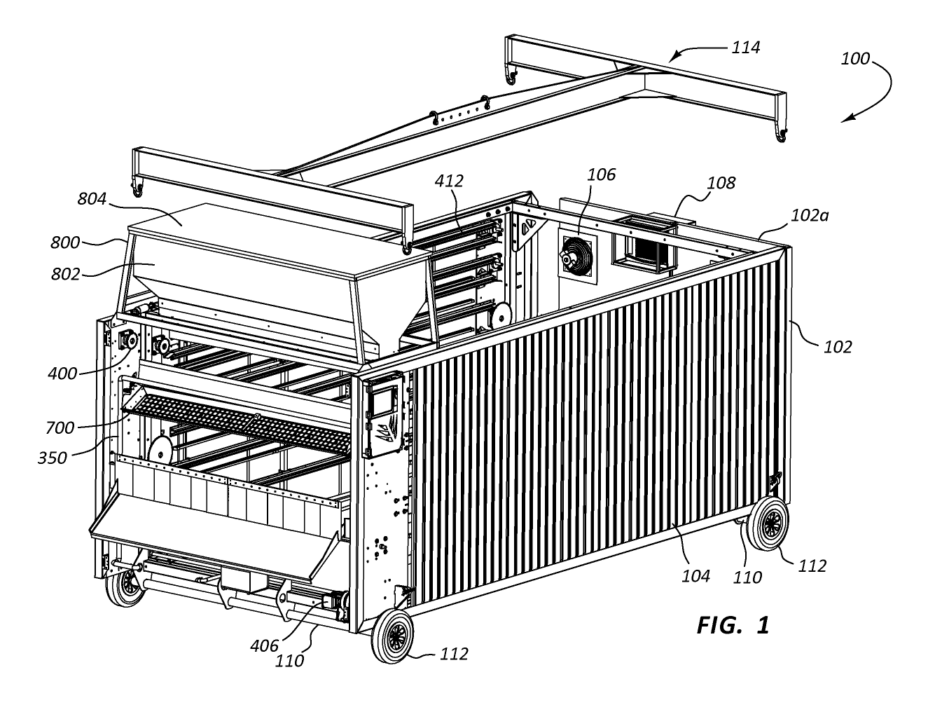

Directing attention now to FIGS. 1-13, details are provided concerning some example structural and operational aspects of a foddering machine, an example of which is denoted generally at 100. In some embodiments, the foddering machine 100 includes an enclosure 102. The enclosure 102 may have a steel or aluminum frame 102A, one or more doors (not shown), and include insulation or insulated panels 104 that may be made of lightweight materials such as sheet metal, fiberglass, or other materials. As well, the enclosure 102 may include climate control equipment such as one or more fans 106, vents 107 (which may optionally form part of a ventilation system that includes one or more fans and ductwork) and air conditioning units 108. One or more heaters (not shown) may also be provided. It should be noted that the process of growing fodder with the foddering machine 100 may generate heat that can be recycled for use in connection with aspects of the foddering machine, such as controlling the climate associated with the foddering machine 100.

Additionally, the enclosure 102 may be configured for portability. For example, in some embodiments, the enclosure 102 may include one or more axles 110 that support a pair of wheels 112. Thus configured, the enclosure 102 can easily be moved from one location to another. The axle 110 and wheels 112 are not required however and are omitted in some embodiments. As well, the enclosure 102 is not required in all embodiments and, accordingly, in some cases the foddering machine 100 can be located instead in a building.

Where the foddering machine does include an enclosure 102, a lift rack 114 or similar device can be provided that is sized and configured to releasably attach to the enclosure 102 so that the enclosure 102 can be lifted and moved, such as by a crane for example.

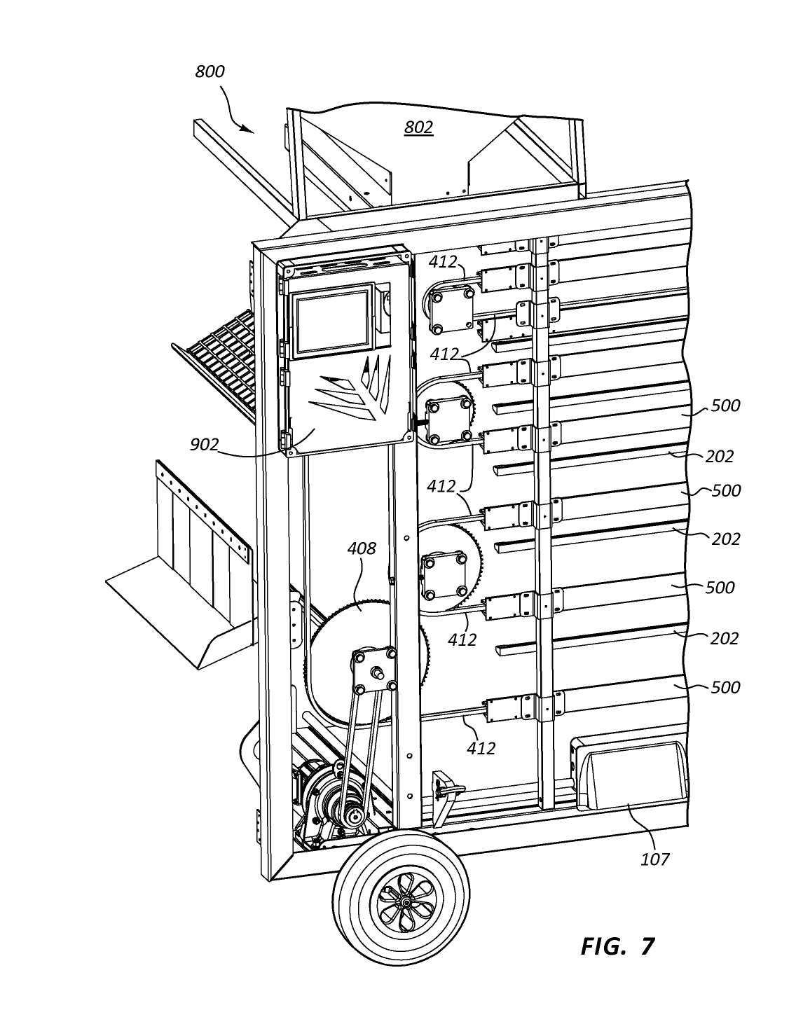

With continued reference to the Figures, the foddering machine 100 also includes a lighting system 200 that includes a plurality of lights 202 configured and arranged to provide light for the seed and fodder. The lights 202 can be configured and arranged in any suitable manner such as in the horizontal orientation shown in the Figures. Particularly, in the illustrated example, the lights 202 are disposed horizontally between successive track elements (see, e.g., FIGS. 7 and 12), but can be arranged in other orientations and locations as well. In some embodiments at least, the lights 202 comprise ultraviolet (UV) light emitting diodes (LED), although other types of lights can alternatively be employed. An outlet, plug or comparable device (not shown) can be provided that enables connection of the lighting system 200 to an external source of power. Where the foddering machine 100 is self-powered, such as by way of solar panels for example, the lighting system 200 is connected to that internal power system.

Embodiments of the foddering machine 100 also include a watering system 300 with a watering manifold 302 having a plurality of outlets 302A that are each connected by tubing or other fluid conduits to a plurality of spray heads 304. Any suitable number and type(s) of spray heads 304 can be employed, and the spray heads 304 can be arranged in any suitable fashion, such as in the vertical rows indicated in the Figures, or horizontally along the seeding trays. The watering manifold 302 is connected to a watering supply line 306 that includes a connection (not shown) for releasably, or permanently, connecting with an external water source.

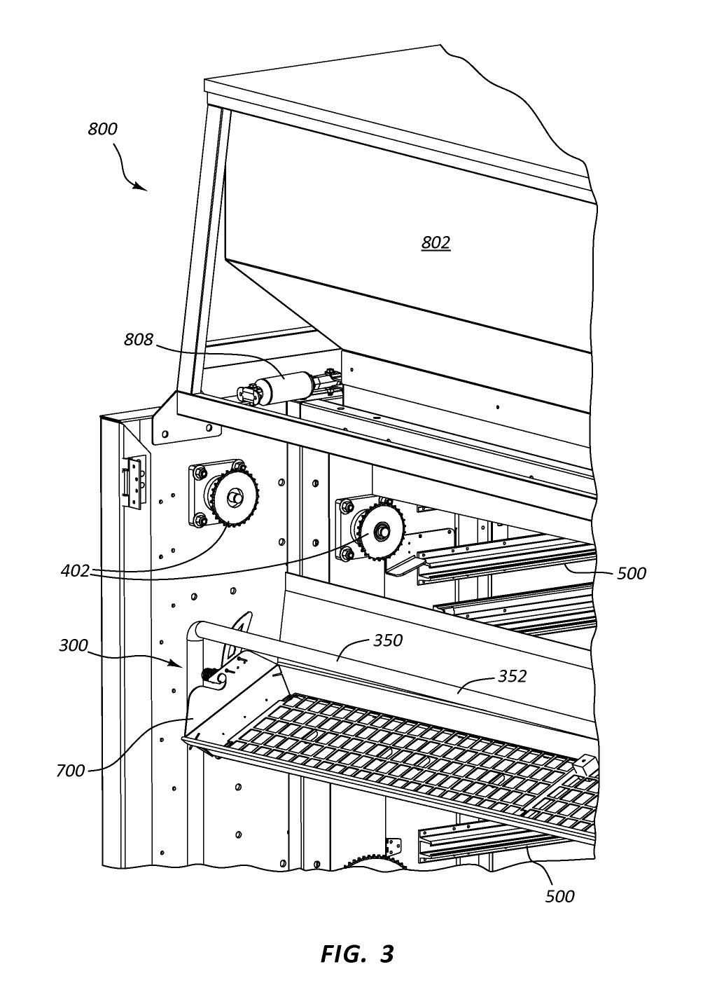

With continued reference to the Figures, embodiments of the foddering machine 100 may also include a cleaning system 350. The cleaning system 350 may use steam as a cleaning medium, although hot water and/or other cleaning media could alternatively be employed. As indicated in the example of FIG. 3, the cleaning system 350 may include pipe 352 or tubing positioned above a seeding tray so that as the empty seeding tray approaches the pipe 352, bursts of steam are expelled through each of a plurality of ports or nozzles (not shown) in the pipe 352 downward into the seeding tray so as to clean and sanitize the empty seeding tray. The pipe 352 of the cleaning system 350 can be connected to an external steam supply. Alternatively, the cleaning system 350 can include a heater that heats excess water sprayed by the watering system as a source of some, or all, of the feedwater needed for steam generation. The excess water can be collected by gutters or other suitable devices that then transport the water to the heater.

The cleaning system 350 may additionally, or alternatively, include a brush (not shown) to sweep material from the empty seeding trays 700. A pipe or tube (not shown) may be provided that is connected to spray heads (not shown) within the brush so that the empty seeding trays 700 can be washed out prior to sanitization with steam.

With reference to the foregoing discussion, it may be desirable to be able to control, manually and/or automatically, remotely and/or locally, one or more of the heating system, cleaning system, air conditioning system, ventilation system, watering system and lighting system. Accordingly, embodiments of the foddering machine 100 may include a control system that provides these and other functions. Example embodiments of a control system are disclosed in further detail elsewhere herein.

With continued reference to the Figures, details are provided concerning a transport system, one example of which is denoted generally at 400. In general, the transport system moves a plurality of seeding trays, discussed below, along a defined path, and over a defined period of time. At the start of the cycle, the seeding trays are empty and at the end of the cycle, the seeding trays contain mature fodder. In this way, and provided that adequate seed, water and power are available, the transport system 400 enables continuous, or substantially continuous, fodder production. Thus, a farmer or other user can be assured that adequate fodder is continuously available. Moreover, the transport system 400 precludes the need for manual movement of the seeding trays. Thus, the growing cycle can proceed day and night without interruption and without requiring operator intervention.

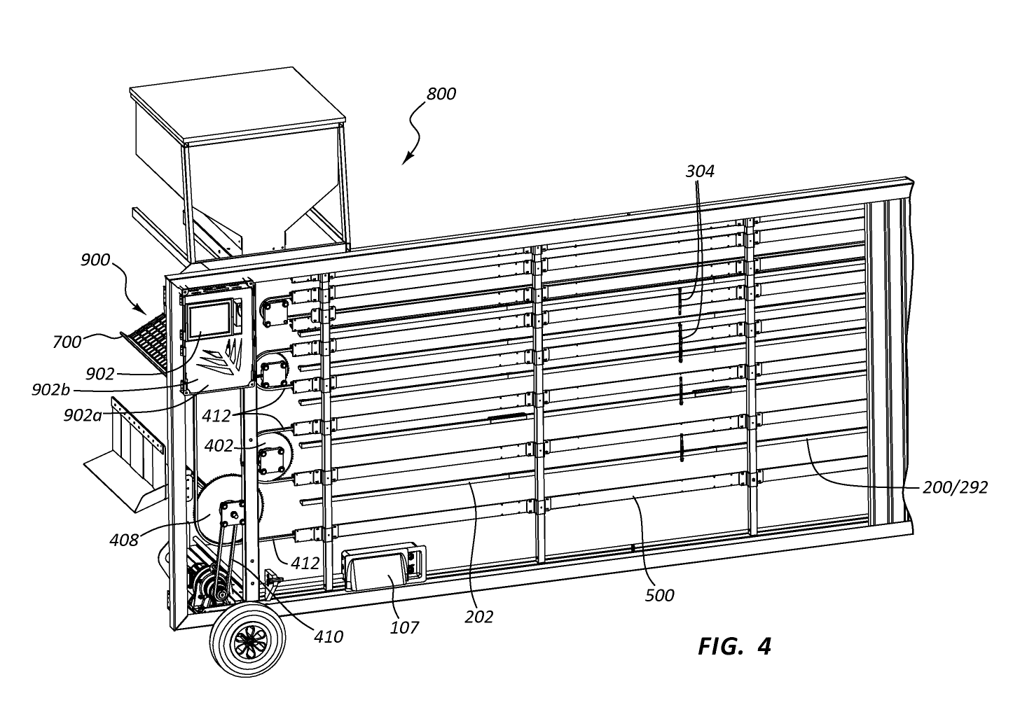

With particular reference to the example of FIGS. 4-7, the transport system 400 may include two sets of pulleys 402, one on either side of the foddering machine 100. The pulley arrangements on the left and right sides of the foddering machine may be substantially the same as, or even mirror images of, each other. The pulleys 402, which can be of varying sizes, that collectively define a path 404. As shown, the pulleys 402 can be mounted to the walls of the enclosure 102, or to a framework (not shown) if an enclosure is not present. As indicated in the Figures, the pulleys 402 may become relatively small in diameter near the beginning 404A of the path 404, and become progressively larger in diameter near the end 404B of the path 404. One consequence of such an arrangement is that a given portion of the transport chain, belt or other element that engages the pulleys 402 may move a relatively shorter distance, per pulley rotation, over the first part of the path 404 and a relatively longer distance, per pulley rotation, over the latter part of the path 404. Because the seeding trays are connected to the transport chain or belt, a comparable effect is realized with respect to the seeding trays.

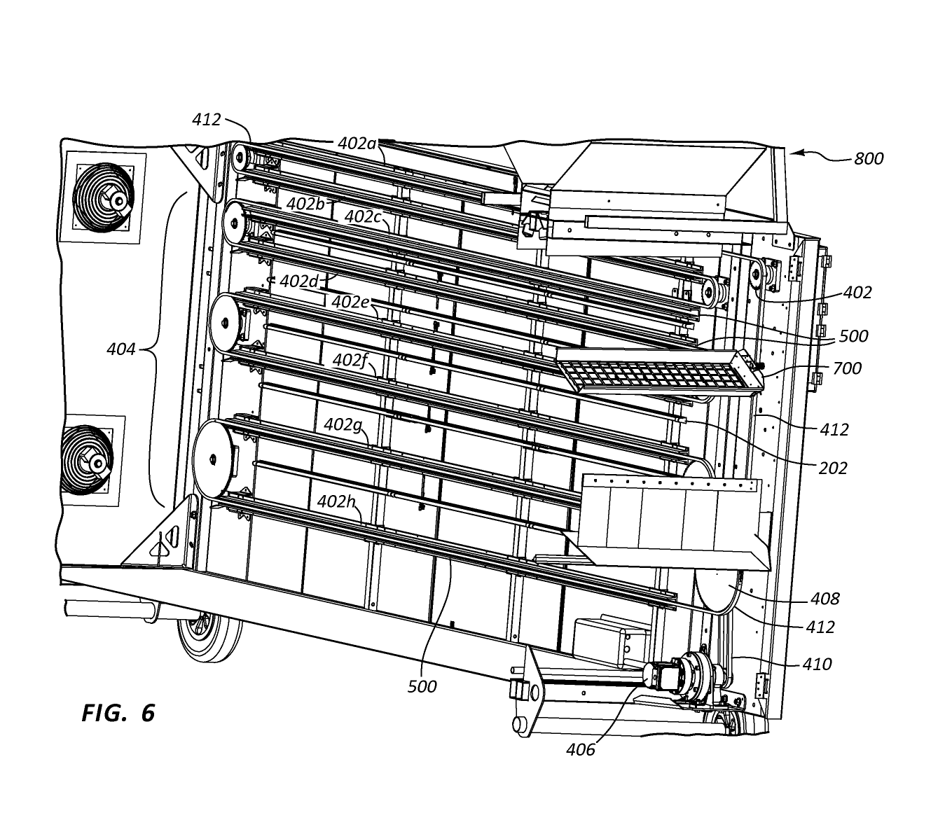

More generally, any one or more of the diameter, number and/or arrangement of pulleys can be varied as necessary to achieve a desired effect with regard to variables such as, but not limited to, the cycle time to produce mature fodder. In similar fashion, the length of the path 404 can be varied by changing any one or more of the diameter, number, and/or arrangement of pulleys. As but one example, the illustrated arrangement includes 4 sets of pulleys on each side of the enclosure 102. The 4 sets of pulleys 402 thus define 8 different vertical positions 402A-402H (see FIG. 6) that can be assumed by each seeding tray. By varying the number of sets of pulleys 402, the number of vertical positions can be increased, or reduced.

As further indicated in FIG. 4-6, the transport system 400 includes a motor 406, that may be electrically powered, or other prime mover that is connected to a shaft of a king pulley 408 by a belt 410, transport chain or other suitable element. The king pulley 408, in turn, is connected to the other pulleys 402 by a transport chain 412. Thus arranged, rotation of the motor 406 shaft causes a corresponding rotational movement of each of the pulleys 402.

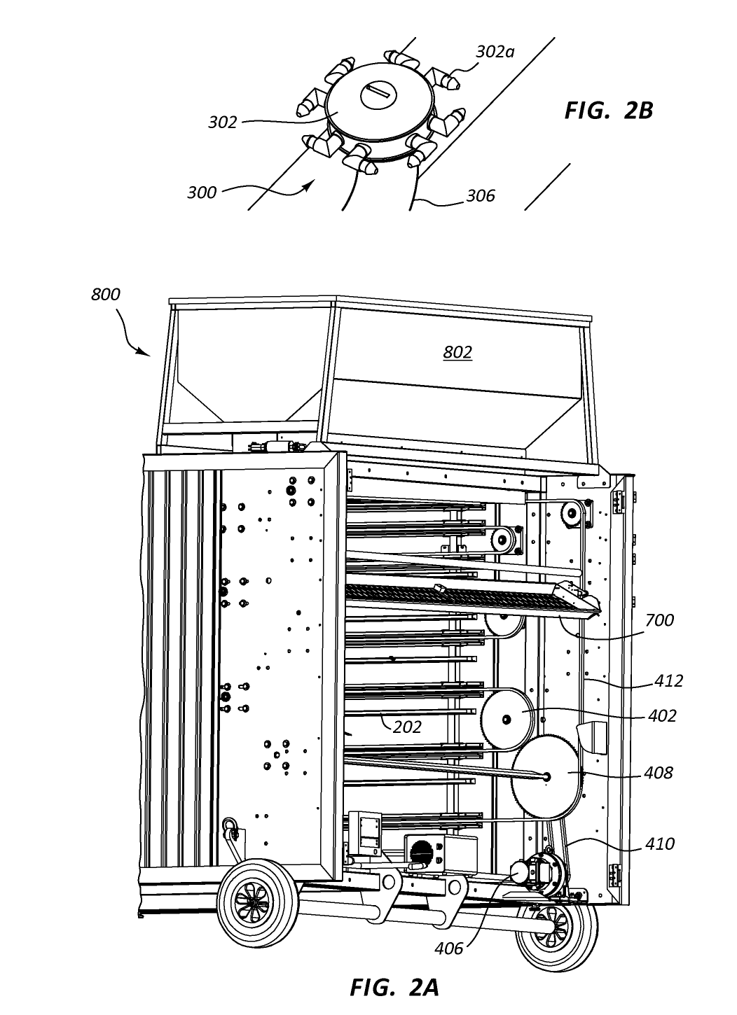

With reference collectively to FIGS. 1 and 2a, only the set of pulleys 402 on the right hand side of the foddering machine 100 (see FIG. 2a) are connected to the motor 406. The set of pulleys 402 on the left hand side of the foddering machine (see FIG. 1) are not connected to the motor 406. Thus, movement of the set of pulleys 402 on the left hand side of the foddering machine 100 is a responsive movement that occurs as a result of movement of the seeding trays under the influence of the set of pulleys on the right hand side of the foddering machine 100.

With the foregoing in mind, it should be understood that a respective motor and king pulley may be provided for each set of pulleys. This arrangement may be desirable if, for example, the seeding trays are sufficiently heavy that a torque is introduced that may be difficult for a single motor to overcome and/or that may cause excessive twisting motions of the seeding trays.

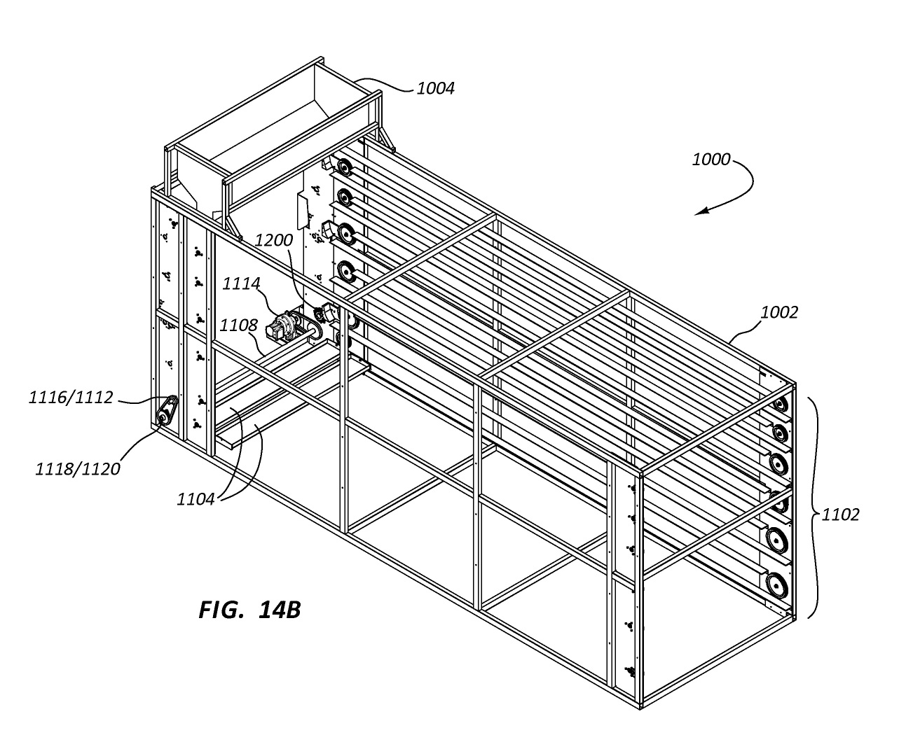

In one example alternative embodiment, discussed below in connection with FIGS. 14a-21b, a single motor is provided that is connected by way of a chain to a sprocket mounted on a transverse shaft. Each end of the shaft includes an additional sprocket that is connected by way of a respective chain to the rest of the transport system. Such an arrangement may, in some circumstances, generate relatively less torque than an arrangement where the shaft is omitted. This reduction in torque can reduce stress and strain on the components of the transport system.

With continued reference now to FIGS. 4-6, a cycle time associated with the foddering machine 100 can be modified by changing the speed of rotation of the motor 406 shaft and/or by changing the diameter of the king pulley 408. Changes to the speed of the motor 406 and, accordingly, the speed of the transport chain 412 and seeding trays, may be accomplished manually and/or automatically. Likewise, changes to the speed of the motor 406 and, accordingly, the speed of the transport chain 412 and seeding trays, can be implemented locally and/or remotely.

The motor 406 can include a protective circuit such that the motor 406 will shut down if excessive resistance to transport chain 412 movement, such as may be caused by a jammed seeding tray for example, becomes excessive. Additionally, or alternatively, the motor 406 can include an overspeed protection circuit that prevents the motor from exceeding a desired rotational output speed. It should be noted that, depending upon the particular embodiment, the motor 406 may run substantially continuously, or the motor 406 may run in discrete intervals of time, punctuated by intervals where the motor 406 is not running

It should be noted that in one alternative embodiment, the transport chain 412 is replaced with a belt, which can be a toothed belt for example, and the pulleys 402 are replaced with pulleys that are configured to engage the belt and be rotated by movement of the belt. Where a transport chain 412 is used, the transport chain 412 can be any suitable type of chain, examples of which include, but are not limited to, single and dual roller chains, conveyor chains, and drive chains.

In some embodiments, one, some, or all, of the pulleys 402 are omitted in favor of a respective sheave that operates in connection with an open link transport chain. In such embodiments, the sheave includes a central groove that receives the links of the open link transport chain. The sheave may include opposing walls that taper toward the central groove so as to help retain the open link transport chain position with respect to the central groove. Further details concerning one example of such a sheave are disclosed elsewhere herein.

With continued reference to the transport system 400, and reference as well to FIG. 12, one or more track elements, one example of which is denoted at 500, can be provided that serve to guide the transport chain 412 along the path 404, and to support the transport chain 412. The track elements 500 can be made of any suitable material and, in one particular embodiment, are made of extruded aluminum, although other materials and/or forming processes can be used in the construction of track elements. In general, the transport chain 412, or belt if applicable, is positioned within a channel 502 defined by the track element 500. The channel 502 is also sized and configured to accommodate support elements, discussed below, that are connected to the transport chain 412.

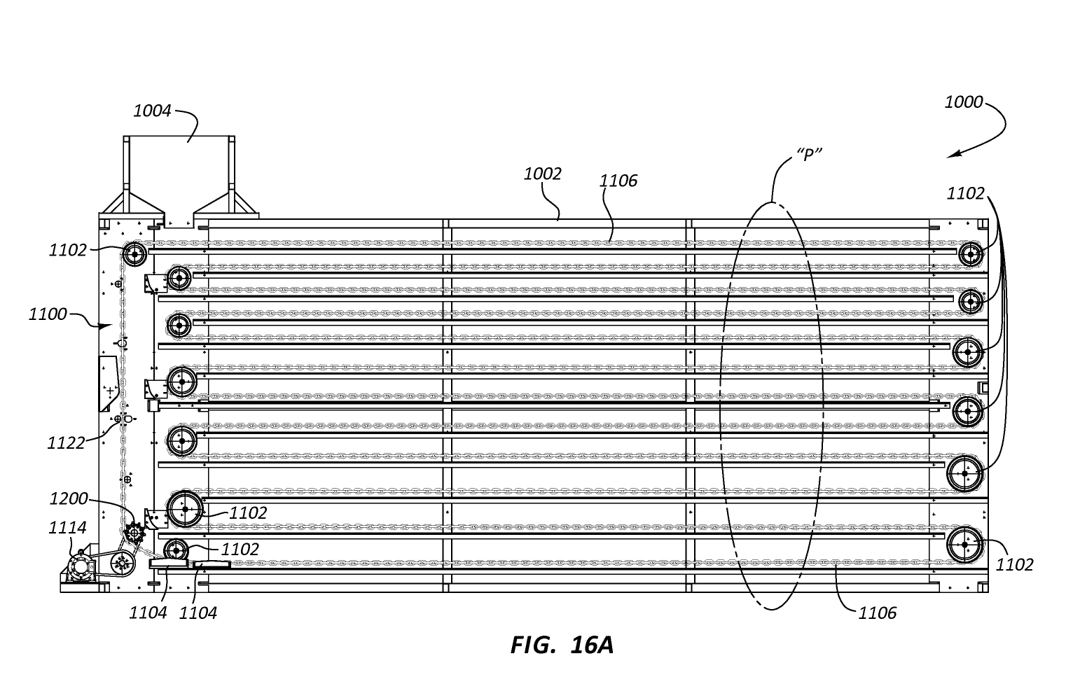

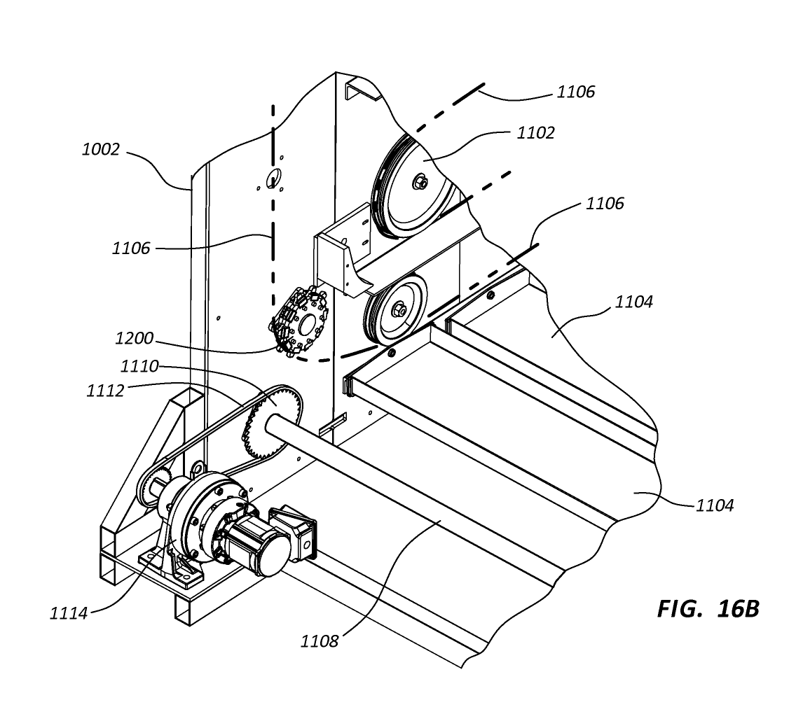

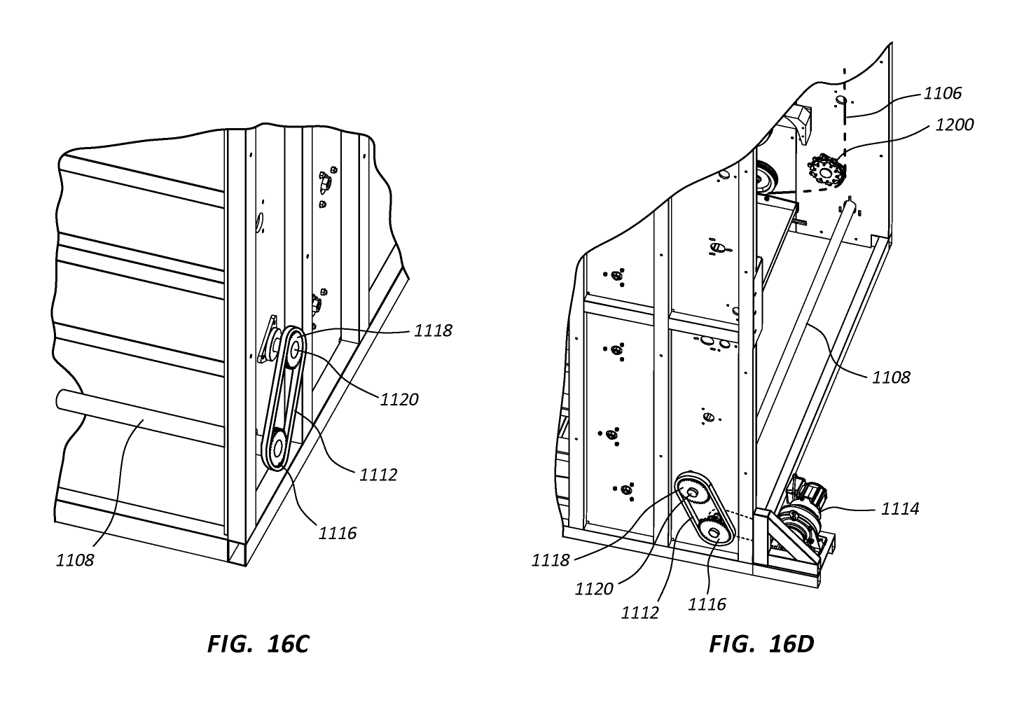

In another embodiment of a track element (see, e.g., FIGS. 14a and 16), the track element takes the form of an angle, such as an angle in the range of about 60 degrees to about 90 degrees for example, such that no channel is formed. Instead, the laterally extending portion of the track element extends above, or below, the transport chain, while the upwardly extending portion of the angle is attached to the frame of the foddering machine.

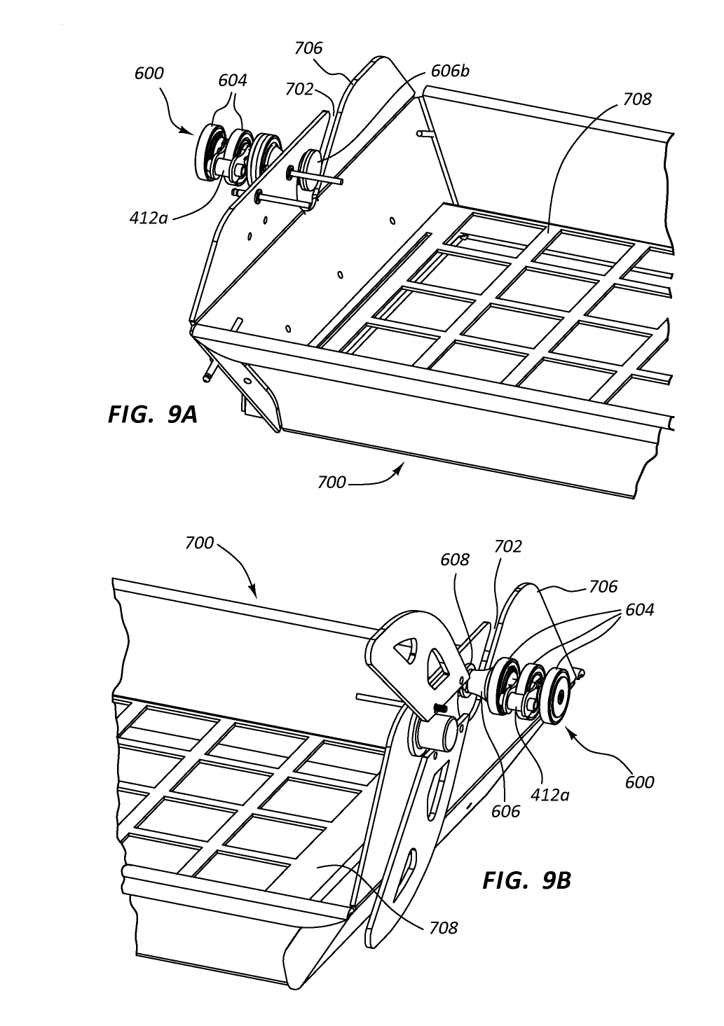

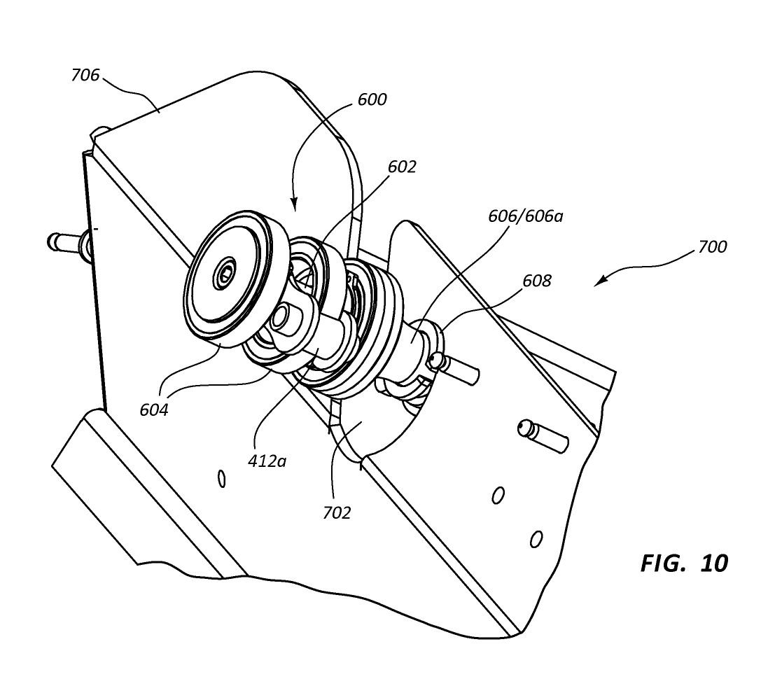

With continued reference to the Figures, and FIGS. 9a, 9b and 10 in particular, where a transport chain is employed as part of the transport system 400, the transport chain 412 is, as noted earlier, configured to transport a plurality of seeding trays 700 (discussed in further detail below). In at least some embodiments, this is achieved through the use of a plurality of support elements, examples of which are denoted at 600. As indicated in those Figures, the support element 600 may be configured with a shaft 602 that extends through a hole defined by a link 412A of the transport chain 412. As a result of this configuration, a special transport chain 412 is not required. Rather, conventional transport chain can be obtained, and then support elements 600 attached to the transport chain.

Any number of support elements 600 can be attached to the transport chain 412. In general, the number of support elements 600 in each of the two transport chains 412 are the same and correspond to the number of seeding trays 700 expected to be transported. The maximum number of seeding trays 700 that can be transported is a function of, at least, the length of the transport chains 412, as well as the size of the seeding trays 700. The spacing of the support elements 600 on the transport chains 412 can be implemented as desired to suit considerations such as the size of the seeding trays 700.

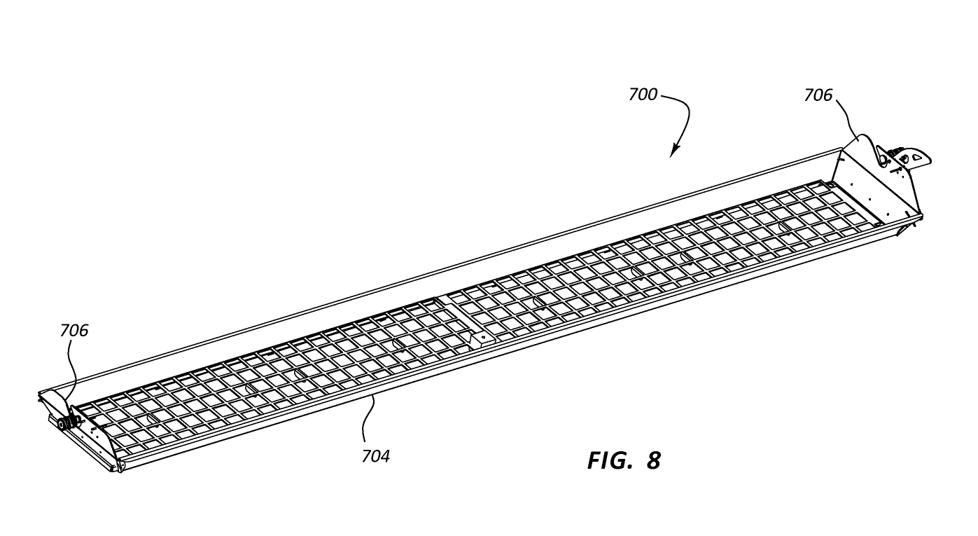

The support elements 600 are arranged so that the support elements 600 in one of the transport chains 412 are disposed substantially directly across from the support elements 600 in the other of the transport chains 412. Thus arranged, each support element 600 in such a pair of support elements 600 supports a respective end of a seeding tray 700, as indicated in FIG. 8 for example.

The support elements 600 may include a pair of bearings 604 that support the shaft 602 so that the shaft 602 is able to freely rotate. As well, the shaft 602 may be received by, or otherwise connected to, a pin 606 that may include a tapered body 606a and is configured to engage a corresponding structure, such as a slot 702 for example, of a seeding tray. The pin 606 may terminate in a flat end 606B that is wider than the tapered body 606A. As indicated in the Figures, the flat end 606B of the pin 606 is wider than the slot 702 and is configured to reside on an inside surface of a seeding tray. The width of the flat end 606B, and the presence of a lock ring 608 or other suitable element(s) serves to reduce, or eliminate, axial movement of the pin 606 relative to the seeding tray 700. Thus, the seeding tray 700 is able to rotate about a longitudinal axis of the pin 606, while the pin 606 remains securely connected to the seeding tray 700. This arrangement thus permits movement of the seeding tray 700 as it transitions between different positions during operation of the foddering machine 100, as discussed in further detail below.

However, because the seeding tray 700 is not fastened to the pin 606, the seeding tray 700 can be removed, such as for maintenance or replacement, by sliding the seeding tray 700 until the pin 606 exits the slot 702. Likewise, the seeding tray 700 is easily installed by simply engaging the pins 606 on either side within respective slots 702 and then moving the seeding tray 700 relative to the pins 606 until the seeding tray 700 assumes the position indicated in FIG. 10.

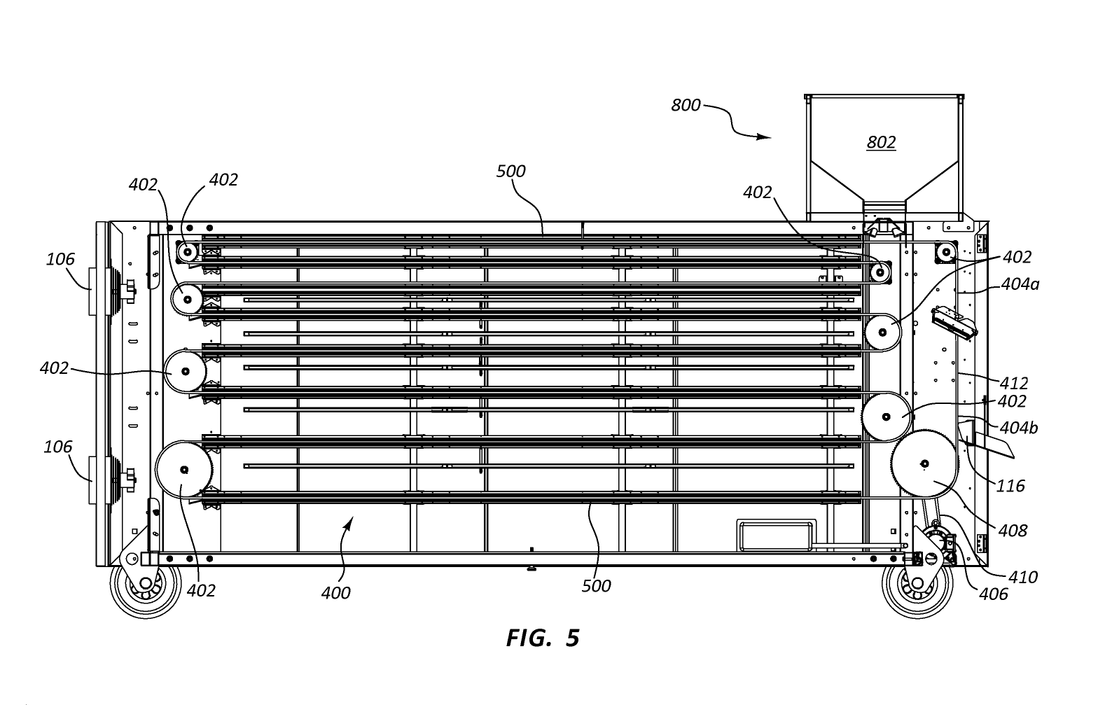

With continued reference to FIGS. 9a, 9b and 10, and also reference to FIG. 8, further details are provided concerning a seeding tray, one example of which is denoted at 700. As indicated in FIG. 8 for example, the tray is generally rectangular in shape and can have any desired length, width and depth. Some embodiments of the seeding tray 700 may have a tilted front wall 704 so that mature fodder is more readily dumped from the seeding tray 700 at harvest time. The seeding trays 700 may also include a cam surface 706 configured to slidingly interact with a corresponding cam structure 116 (see FIG. 5) connected to a frame of the foddering machine 100 so that as a result of upward movement of the seeding tray 700, the cam surface 706 comes into contact with the cam structure 116. The movement of the seeding tray 700, coupled with the respective shapes of the cam surface 706 and cam structure 116, causes the seeding tray 700 to rotate about the axis defined by the pin 606 so as to tilt forward and dump the mature fodder into a collection unit (not shown). To aid in this process, one or both of the cam surface 706 and the cam structure 116 may include a low friction element or coating, such as PTFE for example, on the contact surfaces.

As further indicated in FIG. 8 in particular, the seeding tray 700 may include a permanent, or removable, grid 708 that facilitates drainage of the sprouts/fodder contained in the seeding tray 700. The grid 708 may be made of the same material(s) as the seeding tray 700, although that is not required.

The seeding trays, such as the seeding tray 700 for example, can be made of any suitable material(s). In some cases, the seeding trays are made of a non-rusting metal, such as stainless steel or aluminum, for example. In other cases, the seeding trays can be made of plastic, such as PVC for example, which can be extruded, molded, or otherwise formed.

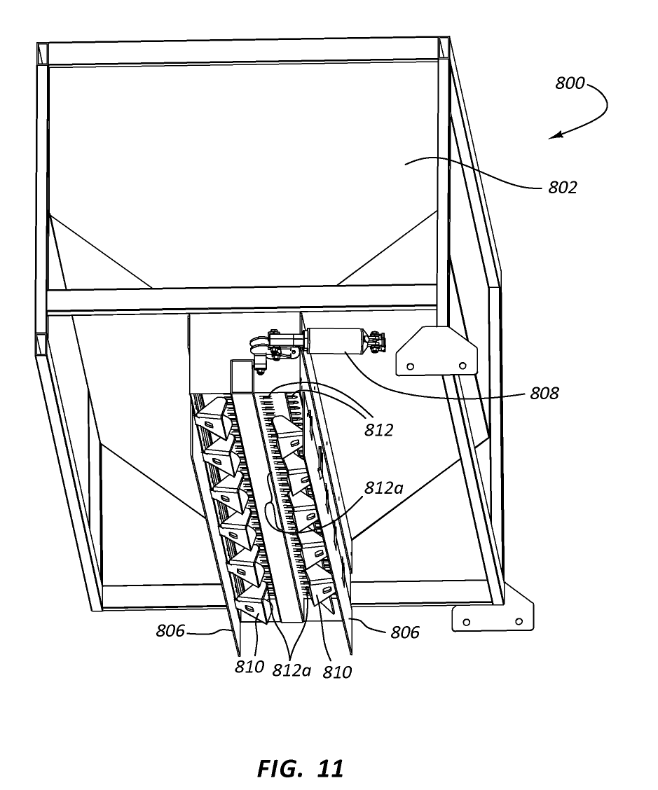

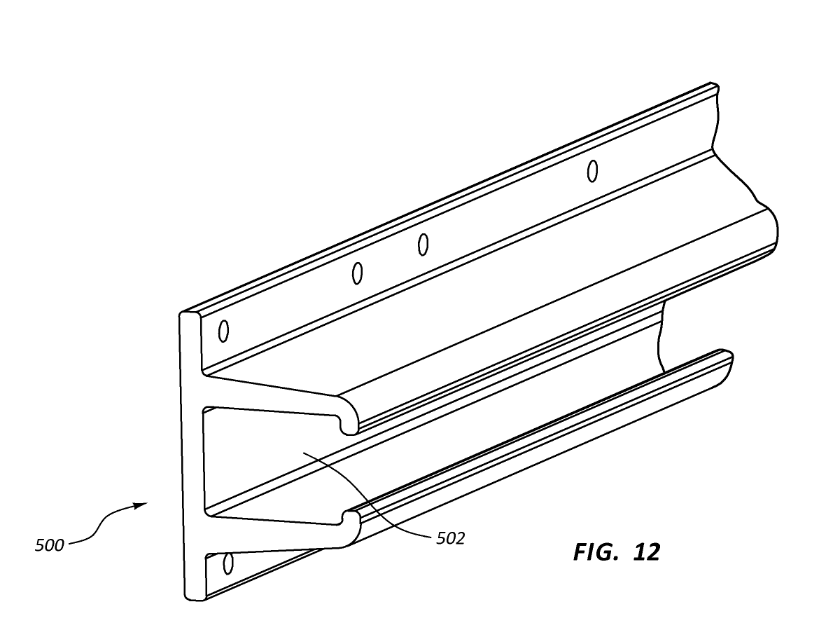

With continued reference to the Figures, the foddering machine 100 may include one or more hoppers 800. The hopper 800 can include a bin 802 that is open at the top and configured to receive a volume of seed. In some embodiments, the bin 802 includes a removable cover 804. A selectively operable flap 806 is connected to the bin 802 and communicates with an opening in the bottom of the bin 802 so that by selectively activating the flaps 806, seed can be dumped from the bin 802. When the desired amount has been dispensed, the flaps 806 can be closed. In some embodiments, an actuator 808 (see FIG. 11) is connected to the flaps 806 and can be used to operate the flaps 806.

The actuator 808 may comprise a hydraulic mechanism, although that is not required, that can be electronically controlled. Thus, at least one embodiment of the foddering machine 100 includes a proximity sensor (not shown) that senses the presence of an element, such as the support element 600, and then causes operation of the actuator 808 and flaps 806 as a result of detection of the element. In such an arrangement, movement of a seeding tray 700 and corresponding support element 600 towards the proximity sensor causes the proximity sensor to trigger operation of the actuator 808 to operate the flaps 806 so that seed is dispensed from the bin 802 into the seeding tray 700 that triggered the proximity sensor.

With continued reference to FIG. 11 in particular, some embodiments of the hopper 800 may include one or more dispersers 810 disposed in an opposing arrangement and offset from each other. In general, the dispersers 810 may serve to direct the flow of seed that has fallen from the bin 802. In some embodiments, the dispersers 810 and/or flaps 806 may be omitted.

As further indicated in FIG. 11, the hopper 800 may include a pair of seed plates 812 arranged one on top of the other. There may be one or two sets of seed plates 812, depending upon the embodiment. The seed plates 812 are configured so that one of the seed plates 812 slides relative to the other seed plate 812. Either seed plate 812 can be the sliding seed plate or the stationary seed plate. A low-friction element (not shown) such as a PTFE plate or layer can be provided between the sliding surfaces of the seed plates 812. Each of the seed plates 812 in a stack of seed plates includes a set of slots 812a that are laterally aligned with corresponding slots 812a of the other seed plate 812 in the stack. As well, the slots 812a are sized and configured such that when the slots 812a of the sliding seed plate 812 in a stack of seed plates are in a first position, the sliding seed plate 812 blocks the slots 812a of the seed plate 812 above it so that seed cannot escape from the bin 802. When the slots 812a of the sliding seed plate 812 in a stack of seed plates are in a second position, the slots 812a of the sliding seed plate 812 are substantially aligned with the slots 812a of the stationary seed plate so as to allow seed to flow from the bin 802. Movement of the sliding seed plate 812 so as to block, or allow, seed flow from the bin 802 can be effected with the actuator 808.

Thus, consistent amounts of seed can be accurately dispensed by controlling the extent to which the seed plates 812 are open, as well as controlling the amount of time that the seed plates 812 remain open. In this way, waste of seed can be reduced, or eliminated, and the overfilling or underfilling of seeding trays can be reduced, or avoided.

### C. Operational Aspects of An Example Embodiment

With continued attention to the Figures, details are provided concerning aspects of the operation of the foddering machine 100. Initially, an empty seeding tray 700 located near the beginning 404A of the path 404 moves upward by virtue of its connection to the transport chain 412, which is moved by the motor 406 and king pulley 408. The seeding tray completes its upward travel and then begins traveling in the horizontal direction away from the front of the foddering machine 100 and toward the hopper 800. As the seeding tray 700 moves horizontally toward the hopper 800, the proximity sensor is triggered and seed is dumped from the bin 802 into the seeding tray 700. The seeding tray 700 is then watered and illuminated by the watering system and lighting system as the seeding tray 700 progresses along the path 404 collectively defined by the transport chains 412. As the seeding tray 700, now bearing mature fodder, nears the end 404B of the path 404, the seeding tray 700 changes from a horizontal motion toward the front of the foddering machine 100 to a vertical motion. As the seeding tray 700 moves upwardly, the cam surface 706 interacts with the cam structure 116 to cause the seeding tray 700 to tilt forward and dump the mature fodder into a collection unit. A ramp may be provided at the front of the foddering machine 100 so that the dumped fodder slides down the ramp and into a collection unit. After the seeding tray 700 has been dumped, the cleaning system 350 is actuated and cleans the now empty seeding tray 700. Once cleaned, the seeding tray 700 begins the cycle again.

### D. Control Systems and Processes

In connection with the foddering machine 100, a control system 900 may be provided. In general, the control system 900 may enable a user to monitor and control the operation of the foddering machine 100 locally and/or from a remote location. For example, the user can program the watering times, water temperature, lighting functions, climate control, and humidity control as well as having the ability to program how much seed is to be used. As well, various sensors, monitors and feedback controls can be included that facilitate automatic adjustments to any of the aforementioned variables, or combinations thereof. A control panel may also communicate with a database so that the effect of changes to one or more variables on growing time, crop size, and other parameters of interest can be identified. This information can be used to drive changes to the operation and control of various aspects of the foddering machine. As well, the control panel may include a wireless communication link so that a telemetry function can be implemented where information collected by monitors and sensors can be transmitted wirelessly to a location remote from where the foddering machine is located.

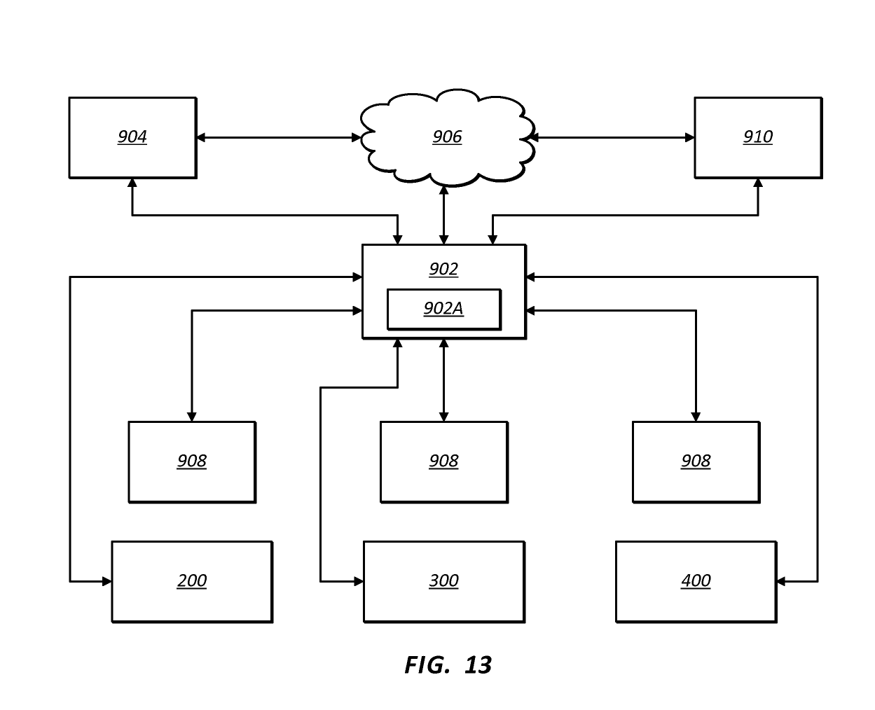

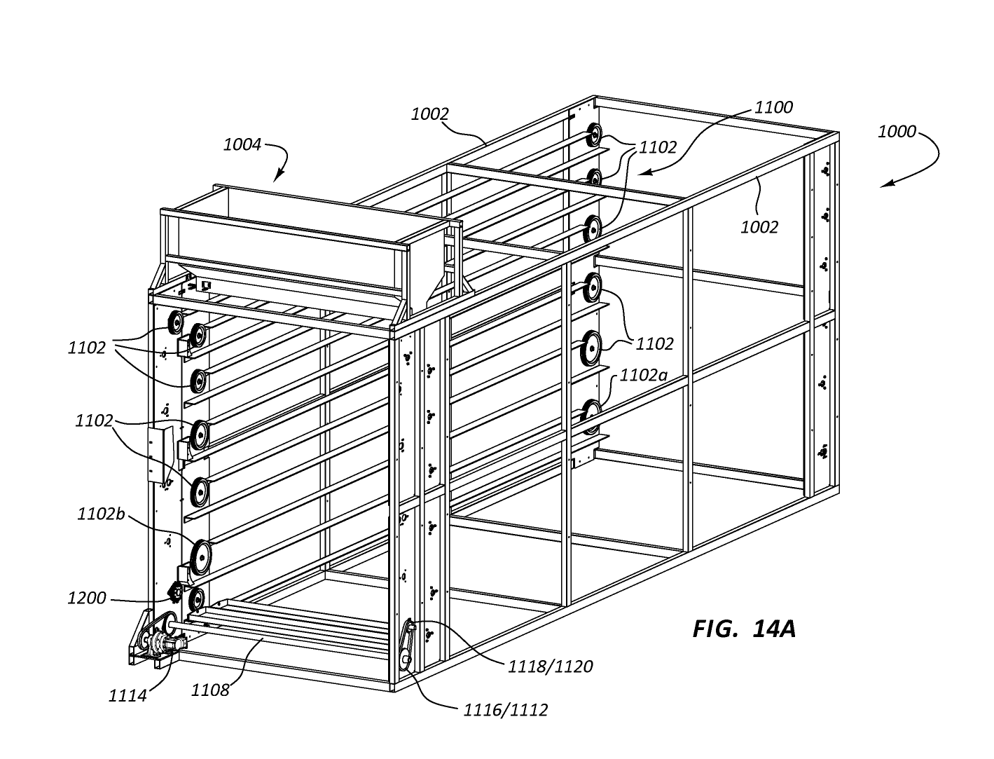

With more particular reference now to FIG. 13, the foddering machine 100 may include a control system 900 that includes a control panel 902 (see, e.g., FIGS. 4 and 13) including, or in communication with, a controller 902A that enables one or more functions to be performed automatically. The control panel 902 can include a touch screen and/or any other suitable user interface(s) and may be located near, or on, the foddering machine 100. The control panel 902 can be housed in a weatherproof enclosure 902b. The control panel 902 may include, or communicate with, a database 904 which may also be accessible remotely by users through a network 906, examples of which include LANs and WANs, using a wireless, or hardwire, connection. As well, the control panel 902 may take the form a network node that can communicate with other network nodes, such as remote users 910 for example, by way of the network 906 and/or directly. Such connections can be hardwire, or wireless. The database 904 can store any data collected and/or generated by the control system 900. The control system 900 can include one or more sensors 908 that collect data concerning any aspect(s) of the operation of the foddering machine 100, as well as data concerning the environment within the enclosure 102 or other area where the foddering machine 100 is located. Examples of environmental parameters concerning which data can be collected by such sensors 908 are disclosed elsewhere herein. Data provided by the sensor 908 may optionally be used as a basis for controlling the operation of one or more of the elements of the foddering machine 100 such as, for example, the watering system 300, lighting system 200, and transport system 400. Additionally, or alternatively, elements such as the watering system 300, lighting system 200, and transport system 400 may also directly provide input to the controller 902A.

As part of, or separate from, the sensors 908, one or more alarms (not shown) can be provided that locally and/or remotely advise a user or operator as to an alarm condition concerning operation of the foddering machine 100. Example alarm conditions include, but are not limited to, over or under-watering, high or low environment temperature, high or low humidity, high or low water temperature, high or low ventilation rate, and high or low gas concentration, such as oxygen or carbon dioxide. These alarms may permit a user to take corrective actions and, in some cases, may enable the controller 902A to automatically take corrective actions and also notify a user of the condition and corrective action taken.

As noted herein, any one or more aspects of the operation of the control system 900 can be controlled locally by the control panel 902 and/or remotely. In some embodiments, an application (APP) is provided that can be employed on a user 910 device, such as a so-called smartphone, so that a user can remotely control operation of the foddering machine 100.

### E. Useful Aspects of Some Example Embodiments

As will be apparent from the disclosure, one or more embodiments of the invention, such as the foddering machine 100 and control system 900 for example, can provide one or more advantageous and unexpected effects, in any combination, some examples of which are set forth below. It should be noted that such effects enumerated herein are neither intended, nor should be construed, to limit the scope of the claimed invention in any way.

For example, the foddering machine 100 may be advantageous inasmuch as it requires little or no user intervention for operation. Thus, costs and time of operation may be reduced. As well, the control system 900 may enable fine tuning of a variety of operational and environmental parameters concerning generation of the fodder so that efficient growing processes are realized. As another example, remote operation of the foddering machine 100 may be advantageous inasmuch as it permits a user to observe and control operation of the foddering machine 100 even when it, or the user, is in a remote location.

### F. Aspects of An Alternative Embodiment

Directing attention now to FIGS. 14a-21b, details are provided concerning an alternative embodiment of a foddering machine, denoted generally at 1000. Except as noted below, this alternative embodiment can be similar, or identical, in terms of included components, construction, and operation, to the embodiment disclosed in FIGS. 1-13 herein.

With particular attention first to FIGS. 14a through 17, the foddering machine 1000 includes a transport system 1100. The transport system 1100 may be configured without the use of any roller bearings, thereby avoiding the maintenance burden associated with maintaining and lubrication such bearings, and also avoiding the corrosion problems that might otherwise attend the use of roller bearings.

As indicated in the Figures, the foddering machine 1000 includes a wall 1002 on which various elements of the transport system 1100 are mounted. In particular, a series of sheaves 1102 are arranged on an interior of the wall 1002 of the foddering machine 1000. Note that while only the left wall 1002 of the foddering machine is indicated in FIGS. 14a and 14b, the number and arrangement of sheaves 1102 on the right interior wall (not shown) is similar, or even identical, to that indicated with respect to the left wall 1002. In general, and as discussed in more detail in connection with the embodiment of FIGS. 1-13, the sheaves 1102 enable a series of seeding trays 1104 (see, e.g., FIGS. 14a and 16b) to be transported both lengthwise, and vertically, with respect to an interior of the foddering machine 1000.

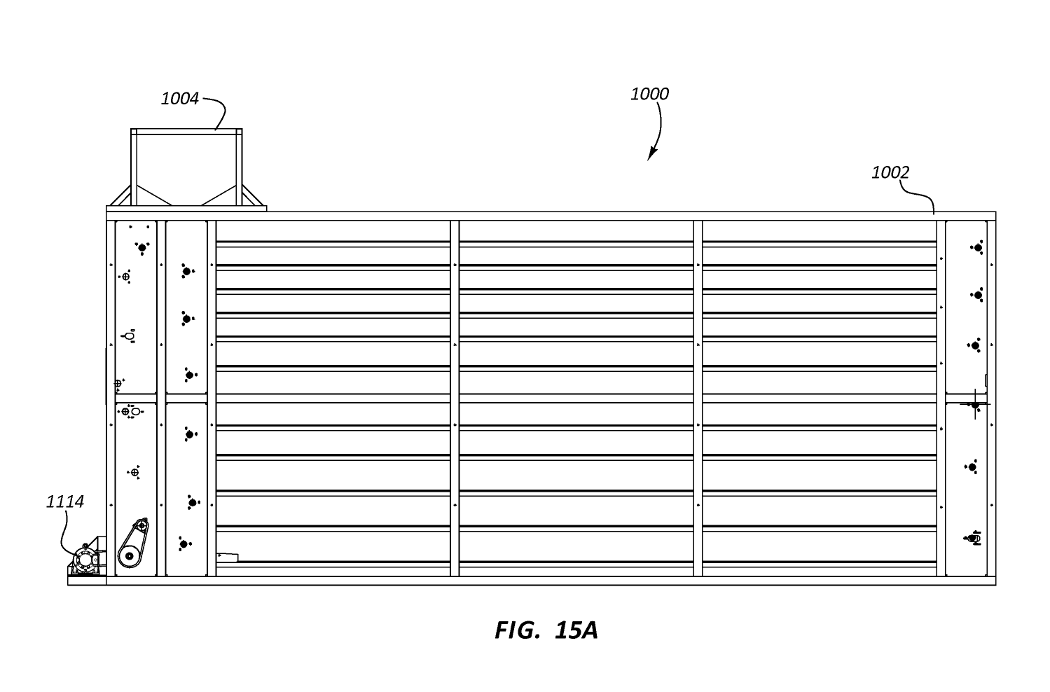

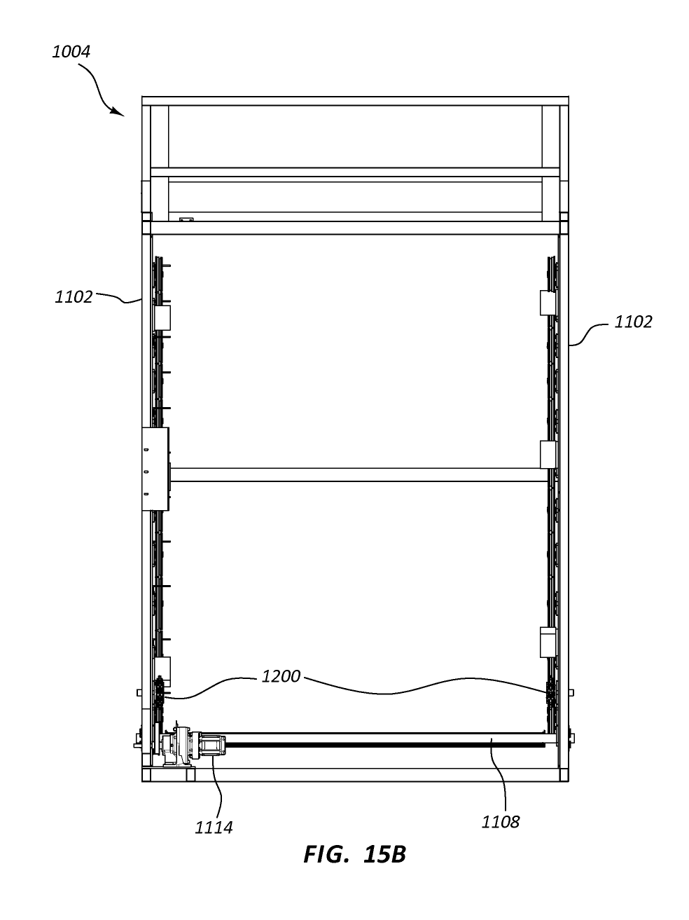

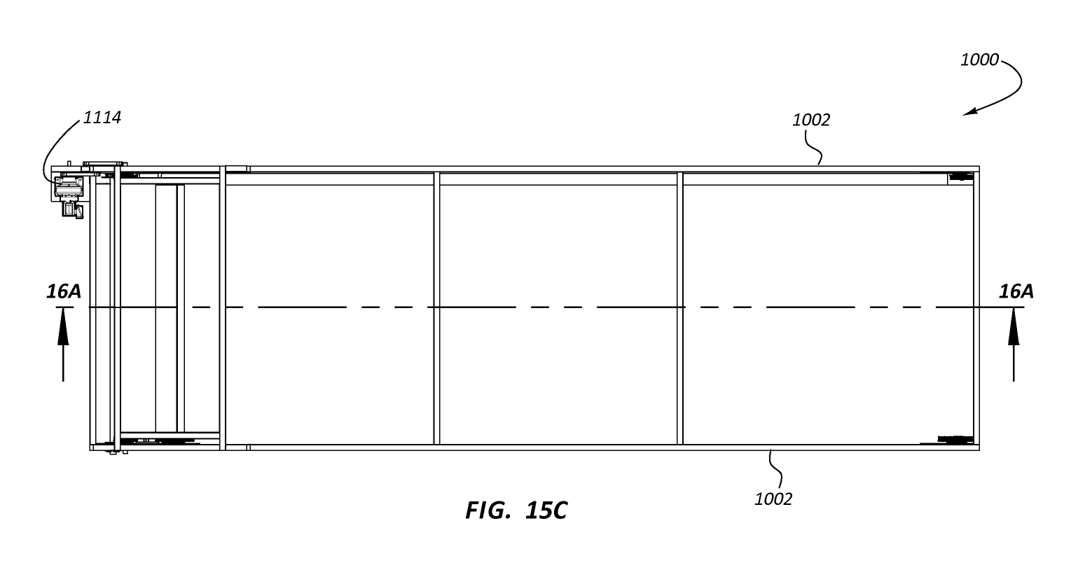

In more detail, and with continuing reference to FIGS. 14a and 14b in particular, the sheaves 1102 are arranged such that, for example, a drive element such as a transport chain 1106 (see, e.g., FIG. 16a), which may be an open link transport chain for example, engages the top of sheave 1102a, located near the rear of the foddering machine 1000, and the bottom of sheave 1102b, which is located near the front of the foddering machine 1000. Thus arranged, and with reference now to FIGS. 15a-16d as well, the sheaves 1102, when employed in concert with other elements of a transport system such as the transport system 1100, can enable transport of a series of seeding trays 1104 along both the length and height of the foddering machine 1000. It will also be apparent that the transport system 1100 thus serves to convey the seeding trays 1104 generally in a closed serpentine path “P” (see, e.g., FIG. 16a) that is collectively defined at least in part by the sheaves 1102, and which begins near the top of the foddering machine 1000, proximate a hopper 1004 for example, and extends to the bottom front of the foddering machine 1000. The transport chain 1106, which can be an endless chain, follows the path “P” and may include a removable link, or comparable device, to enable the transport chain 1106 to be opened and removed from the foddering machine 1000.

As noted above, the transport chain 1106 may, in some embodiments, take the form of an open link transport chain. Advantageously, open link transport chains are self-cleaning, an attribute that is particularly useful in applications, such as foddering, where materials, such as seeds, fodder, and soil, are present that could clog transport chains of other configurations. Although the transport chain 1106 can be an open link transport chain, that is not required. Thus, in other embodiments, a roller transport chain, drive transport chain, conveyor transport chain, or other type of transport chain, can be used instead of an open link transport chain.

With continued reference to FIGS. 14a, 14b and 16a, for example, the relative sizes of sheaves 1102 in the transport system 1100 can vary from one sheave to another. Thus, for example, one or more of the sheaves 1102 located near the bottom of the foddering machine 1000 may have a relatively larger diameter than one or more of the sheaves 1102 located near the top of the foddering machine 1000. Because the sheaves 1102 must all rotate in such a way that the linear velocity of the transport chain 1106 is constant, or substantially so, in all parts of the transport chain 1106, it will be apparent that the variations in diameter of the sheaves 1102 mean that the relatively smaller sheaves 1102 rotate relatively more quickly than the relatively larger sheaves 1102. That is, the smaller sheaves 1102 have a relatively greater rpm (revolutions per minute) than the relatively larger sheaves 1102.

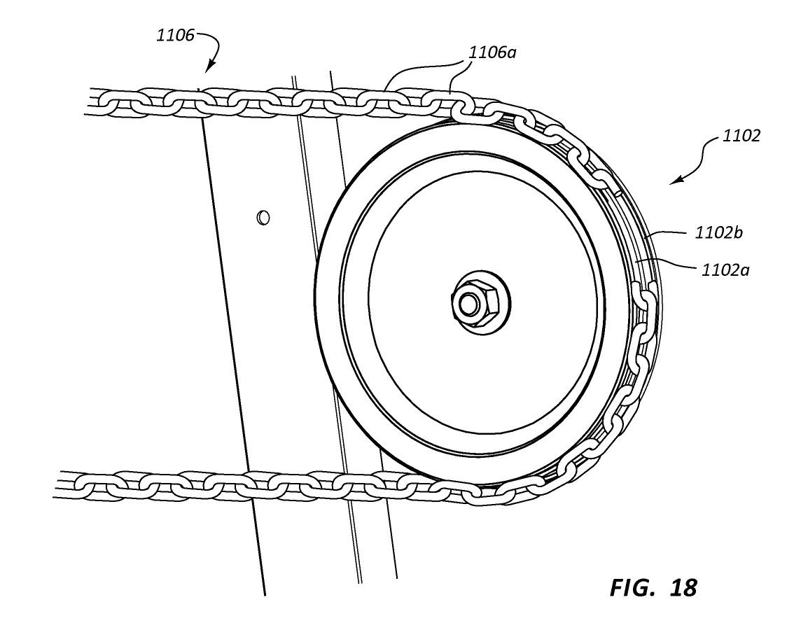

Turning now to FIG. 18, further details are provided concerning an example sheave, such as sheave 1102, that is included in the transport system 1100. The sheave 1102 can be made of any suitable materials, examples of which include, but are not limited to, stainless steel, and aluminum. As well, the sheave 1102 can be made by casting, machining, and/or other suitable processes.

As noted earlier, the example sheave 1102 is configured to engage the transport chain 1106, which may be an open link transport chain. Accordingly, the sheave 1102 may include a central groove 1102a on either side of which a sloping wall 1102b is disposed. The sloping walls 1102b may help to guide links 1106a of the transport chain 1106 into the central groove 1102a, and the configuration of the central groove 1102a may help retain the links 1106a of the transport chain 1106 in a desired axial and/or radial position with respect to the sheave 1102. Thus configured and arranged, the sheaves 1102 serve to guide the travel of the transport chain 1106. As discussed below, movement of the transport chain 1106 is effected by way of a drive motor, shaft, and one or more sprockets.

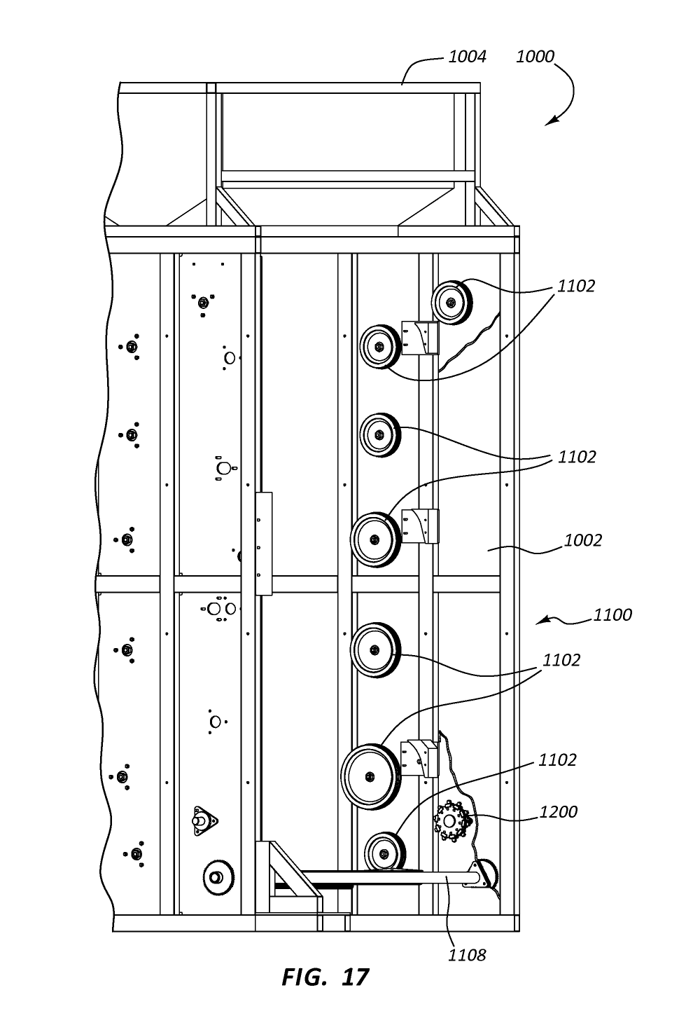

With continuing attention now to FIGS. 16a-16d and FIG. 17, the transport system 1100 further includes a shaft 1108 that extends transversely across the front of the foddering machine 1000. A sprocket 1110 mounted to the shaft 1108 is connected, by way of one or more roller chains 1112 for example, to an output shaft of a motor 1114. As well, drive sprockets 1116 are mounted to portions of the shaft 1108 that extend through the interior walls 1002. Each drive sprocket 1116 is, in turn, connected to a respective driven sprocket 1118 that is mounted to a shaft 1120 at a location on the exterior of the foddering machine 1000. Each shaft 1120 extends to the interior of the foddering machine 1000, and a transport sprocket 1200 is mounted to each shaft 1120 in the interior of the foddering machine 1000. The shafts 1120 may each include a stop 1120a or other structure to help retain the transport sprocket 1200 in a desired axial position along the shaft 1120. In general, and as discussed in more detail below, the transport sprocket 1200 releasably engages the transport chain 1106 and moves the transport chain 1106, to which the seeding trays 1104 are connected, in response to rotation of the output shaft of the motor 1114. As indicated in FIG. 16a, one or more fairleads 1122 may be provided that serve to guide the transport chain 1106 onto and/or off of the transport sprocket 1200.

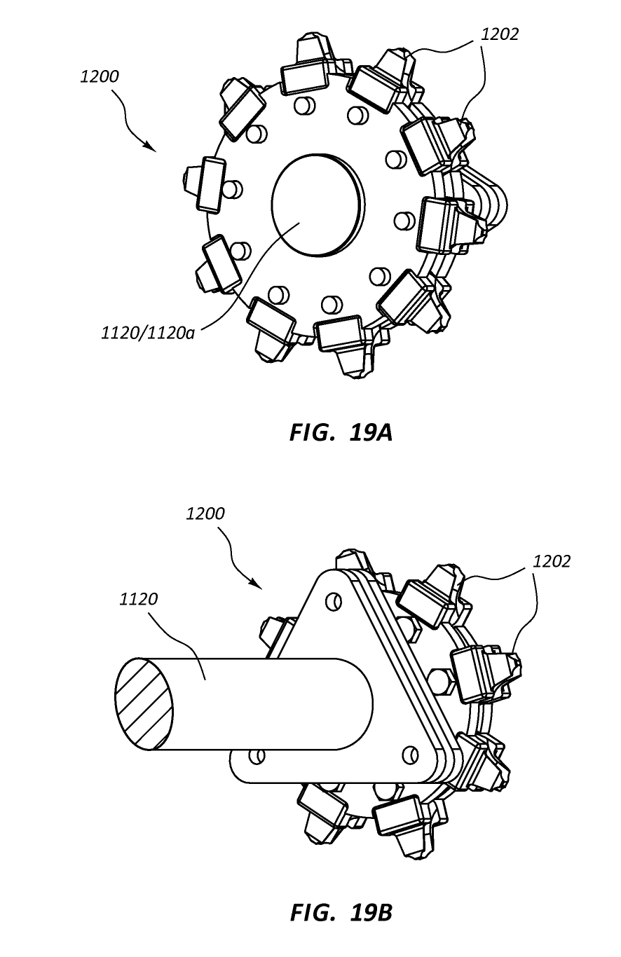

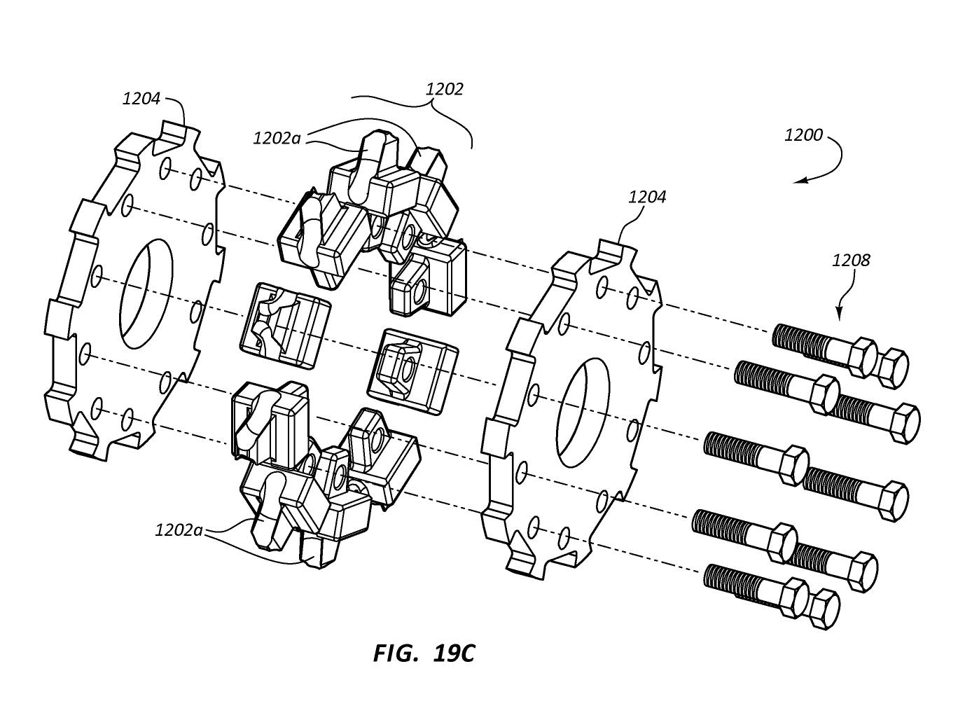

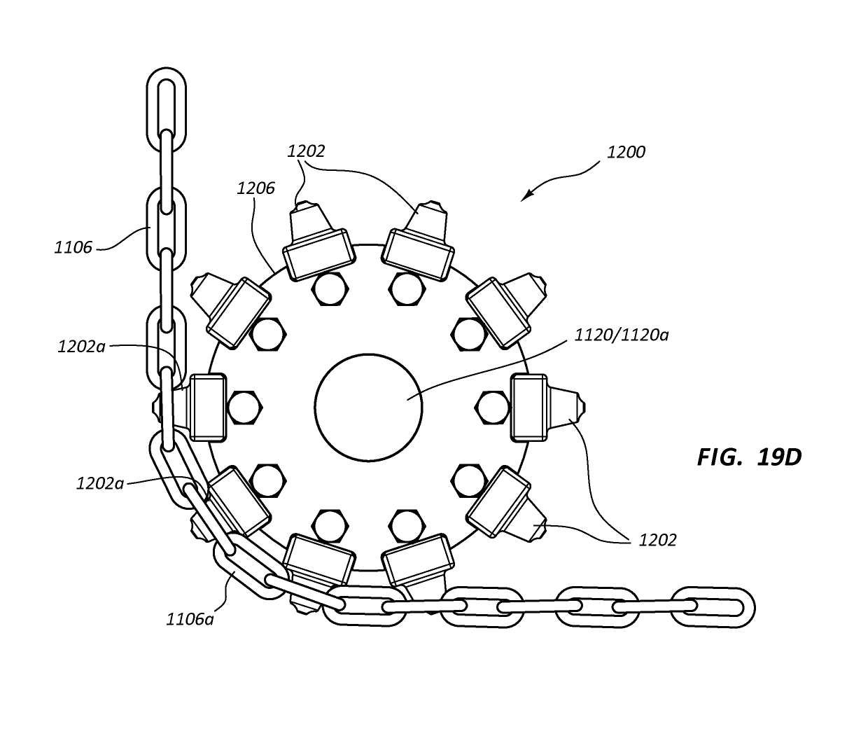

Directing attention now to FIGS. 19a-19d, details are provided concerning an example transport sprocket, such as transport sprocket 1200. The transport sprocket 1200 can be made of any suitable metal(s), one example of which is stainless steel. In at least some embodiments, the transport sprocket 1200 is machined, although portions of the transport sprocket 1200 may be cast or otherwise formed instead.

As indicated, the transport sprocket 1200 includes a plurality of teeth 1202. The teeth 1202 can be formed by machining, or other suitable process(es). Each of the teeth 1202 is sized and configured to engage every other link 1106a of an open link transport chain, such as the transport chain 1106 for example. That is, not every link 1106a in the transport chain 1106 engages a tooth 1202 of the transport sprocket 1200. Rather, and as shown in FIG. 19d, only every other link 1106a in the transport chain 1106 engages a tooth 1202 of the transport sprocket 1200.

In more detail, the transport sprocket 1200 includes first and second halves 1204 that can be integral with each other, or which may comprise discrete components attached to each other with bolts and/or other fasteners. The first and second halves 1204 cooperate to define a groove 1206 in which a side of every other link 1106a is received. Additionally, each tooth 1202 includes a pair of fluted sides 1202a, each of which is aligned with the groove 1206, and configured and arranged to receive an end of every other link 1106a. The fluted sides 1202a of the teeth 1202 may have a shape that generally corresponds with a shape of the end of the links 1106a. In particular, a curvature of the fluted sides 1202a may be similar, or identical, to a curvature of the end of the links 1106a.

As well, the depth of the fluted sides 1202a of the teeth 1202 may be such that a portion of a link 1106a is received within the tooth 1202 as the link 1106a moves along the transport sprocket 1200. The teeth 1202 thus help to retain the links 1106a in a desired lateral position and prevent the links 1106a from slipping off the transport sprocket 1200, even if the links 1106a are subjected to lateral forces, that is, forces that include a component in a direction that is generally parallel to a longitudinal axis defined by the shaft 1120 to which the transport sprocket 1200 is mounted.

In at least some embodiments, the teeth 1202 are removable from the transport sprocket 1200. For example, and as indicated in FIGS. 19c and 19d, each of the teeth 1202 can be attached to the transport sprocket 1200 by way of a corresponding bolt 1208 and nut (not shown). A washer (not shown) and lock washer (not shown) may also be used to help retain each tooth 1202. Because the teeth 1202 may be subjected to significant wear, stress and/or strain during operation of the foddering machine 1000, the ability to remove and replace the teeth 1202 of the transport sprocket 1200 can be advantageous. Moreover, the teeth 1202 of the transport sprocket 1200 can be removed and replaced with teeth of a different configuration, so as to enable use of a different size and/or type of chain.

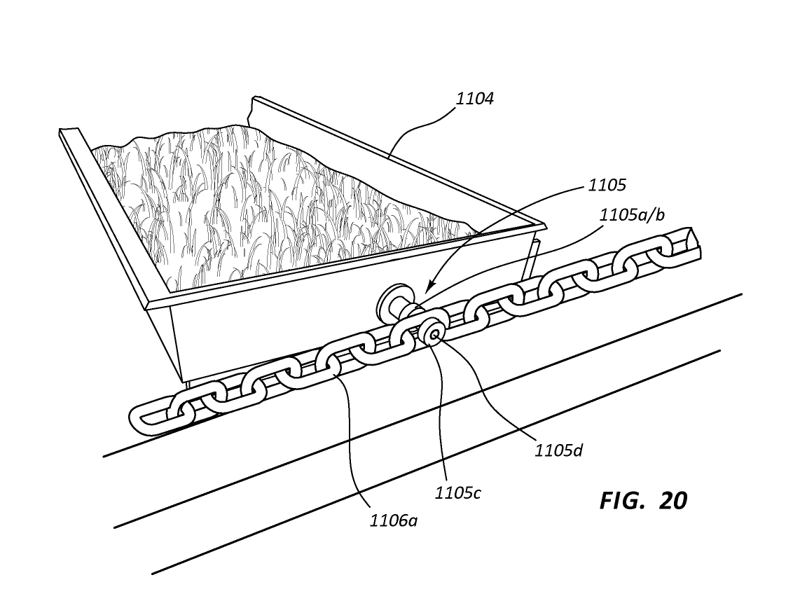

Turning now to FIG. 20, further details are provided concerning the example seeding tray 1104 which, as noted elsewhere herein, the seeding tray 1104 can be made of plastic, although that is not required. As shown in the Figures, the seeding tray 1104 may be releasably connected to the transport chain 1106 by way of a stud 1105 that is threaded at each end. More particularly, an externally threaded end 1105a of the stud 1105 extends into the seeding tray 1104 and is removably retained in position with a nut and washer. The other, internally threaded, end 1105b of the stud 1105 extends through the side of the seeding tray 1104. The internally threaded end 1105b includes a flare that is positioned between the transport chain 1106 and the outer edge of the seeding tray 1104 to prevent movement of the transport chain 1106 toward the seeding tray 1104.

A cap 1105c that includes a flare is passed through the link 1106a and engages the end 1105b so that the link 1106a is held between the respective flared portions of 1105b and 1105c. The cap 1105c is retained in position by a threaded fastener 1105d that extends through the top of the cap 1105c and engages the internal threads of end 1105b. By removing the threaded fastener 1105d, a user can then disengage the seeding tray 1104 from the transport chain 1106.

It should be noted that the stud 1105, including its various components, is an example structural implementation of a means for releasably connecting a seeding tray to a transport chain. Any other structure(s) capable of performing this function can alternatively be employed. The stud 1105 may perform additional functions as well, such as implementing self-alignment of the seeding tray 1104.

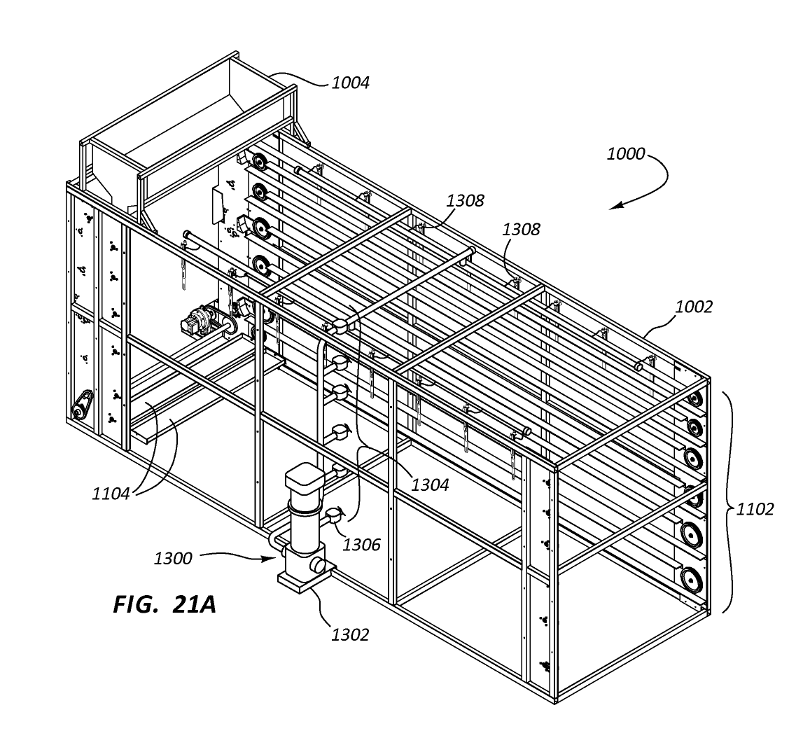

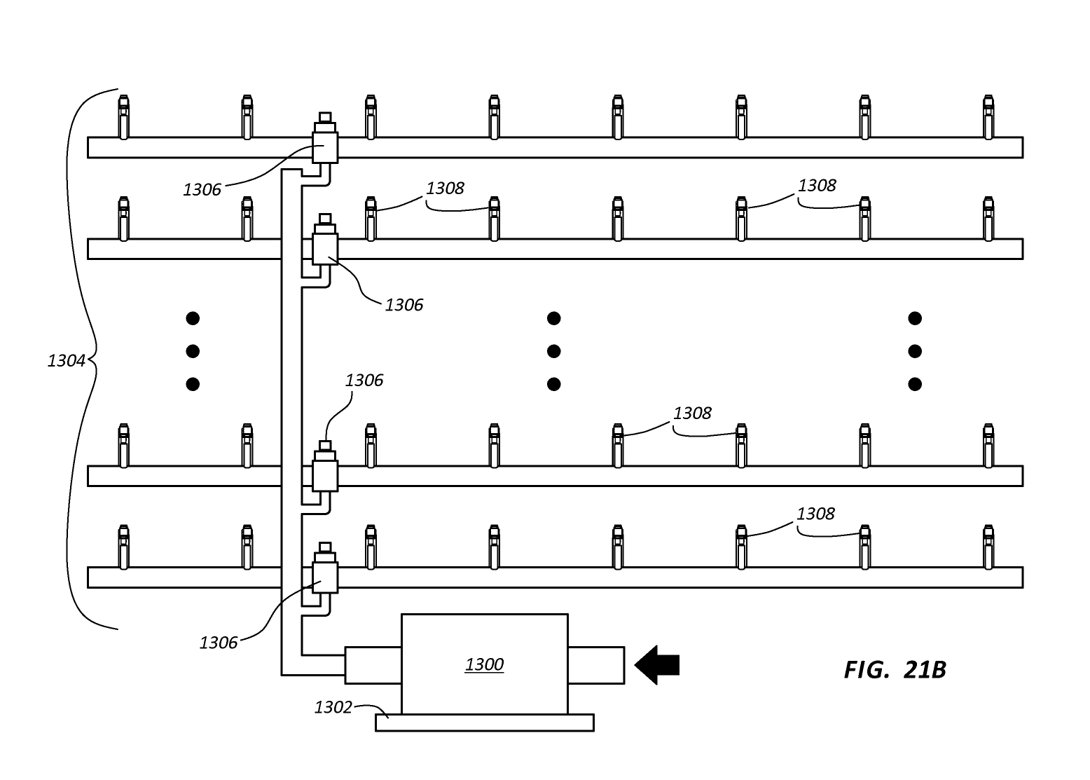

With reference, finally, to FIGS. 21a and 21b, details are provided concerning example components of a watering system 1300. As indicated in FIG. 21a, one or more pumps 1302 may be provided that draw water from a source and convey the water to a watering system of the foddering machine 1000. One example of such a watering system is discussed elsewhere herein in connection with the foddering machine 100. A watering system 1300 for the foddering machine 1000 may additionally include a watering control system 1304 which may comprise, among other things, solenoid valves 1306 and/or other devices for controlling the flow of water to the seeding trays 1104, as well as jets or nozzles 1308. The watering control system 1304 can be a part of the control system disclosed in FIG. 13.

Although this disclosure has been described in terms of certain embodiments, other embodiments apparent to those of ordinary skill in the art are also within the scope of this disclosure.

What is claimed is:

1. A foddering machine, comprising:
a plurality of seeding trays;
a transport system engaged with the seeding trays and operable to move the seeding trays between a plurality of vertical and horizontal positions, wherein the transport system comprises:
a plurality of sheaves;
a transport sprocket;
a transport chain configured to engage the sheaves and transport sprocket; and
a motor coupled directly, or indirectly, to the transport chain;
a watering system configured and arranged to dispense water into the seeding trays;
a lighting system configured and arranged to provide light to contents of the seeding trays;
a hopper positioned to dispense seed into successive seeding trays; and
an automatic control system operably coupled to the transport system, watering system, lighting system and hopper, wherein, in operation, the automatic control system automatically controls the operation of the transport system, watering system, lighting system and hopper.

2. The foddering machine as recited in claim 1, further comprising a proximity sensor operably connected with the hopper, transport system and automatic control system, such that a predetermined motion of a seeding tray causes a corresponding operation of the hopper.

3. The foddering machine as recited in claim 1, wherein the automatic control system is operable from a location remote to the foddering machine.

4. The foddering machine as recited in claim 1, wherein the seeding trays each include a cam surface that enables the seeding trays to be automatically dumped.

5. The foddering machine as recited in claim 1, wherein the automatic control system includes a touch screen control panel in communication with one or more sensors and monitors associated with one or more functions of the foddering machine.

6. The foddering machine as recited in claim 1, wherein the automatic control system includes a data logger in communication with one or more sensors and monitors associated with one or more functions of the foddering machine.

7. The foddering machine as recited in claim 1, further comprising an enclosure within which the seeding trays, transport system, water system and lighting system are substantially disposed.

8. The foddering machine as recited in claim 7, wherein the automatic control system is operable to control a climate inside the enclosure.

9. The foddering machine as recited claim 1, wherein the automatic control system includes a feedback loop associated with a sensor, wherein the sensor is operable to gather information concerning one or more parameters relating to the operation of the foddering machine.

10. The foddering machine as recited in claim 1, wherein the transport sprocket includes a plurality of removable teeth.

11. The foddering system as recited in 10, wherein the removable teeth include fluted sides that are configured to receive a portion of a chain link.

12. The foddering machine as recited in claim 1, wherein the transport chain is an open link chain.

13. The foddering machine as recited in claim 1, wherein one or more of the sheaves defines a central groove disposed between a pair of sloping walls, the central groove configured and arranged to receive a side of a chain link.

14. The foddering machine as recited in claim 13, wherein the chain link is an open chain link.

15. A method for controlling operation of a foddering machine, comprising:
automatically performing any one or more of the following:
receiving input concerning a parameter relating to operation of the foddering machine;
causing the foddering machine to operate in accordance with the received input for the parameter;
monitoring a value or range of values associated with the parameter to obtain an actual value of the parameter;
comparing the actual value of the parameter with the input; and
adjusting a value of the parameter when a difference between the actual value of the parameter and the input exceeds an acceptable range,
wherein the parameter comprises any one or more of water temperature, water consumption, air temperature, humidity, seed weight and/or volume, carbon dioxide concentration, fodder production cycle time, fodder weight, and power consumption.

16. The method as recited in claim 15, wherein the input is received over a wireless communication link.

17. The method as recited in claim 15, wherein the parameter value is adjusted manually, or automatically.

18. A hardware processor programmed to perform, or cause the performance of, any one or more processes recited in the method of claims 15.

19. A computer program product carrying computer executable instructions that, when executed by one or more hardware processors, cause the performance of one or more processes recited in the method of claim 15.

20. The computer program product of claim 15, wherein the computer program product comprises a mobile phone or other mobile electronic communication device.
